(19) United States
(12) Patent Application Publication
(10) Pub. No.: US 2026/0052352 A1
(43) Pub. Date: Feb. 19, 2026

(54) INDIVIDUALIZED HEAD-RELATED TRANSFER FUNCTION PREDICTION

(71) Applicant: QUALCOMM Incorporated, San Diego, CA (US)

(72) Inventors: Sergej GOLDYREW, Gaimersheim (DE); Thomas PINZ, Pentling (DE); Chun Kun KIM, Cambridge (GB); Graham Bradley DAVIS, Seattle, WA (US); Andrea Felice GENOVESE, Brooklyn, NY (US); Alex TUNG, San Diego, CA (US); Isaac Garcia MUNOZ, San Diego, CA (US)

(21) Appl. No.: 18/803,120

(22) Filed: Aug. 13, 2024

(51) Int. Cl. H04S 7/00

(52) U.S. Cl. CPC H04S 7/30; H04S 2420/01

(57) ABSTRACT

A device includes a memory configured to store a user classification associated with a user of the device. The user classification associates the user with at least one of a plurality of user classifications. The device also includes one or more processors coupled to the memory. The one or more processors are configured to obtain the user classification. The one or more processors are configured to extract, from a latent space head-related transfer function (HRTF) encoding based on the user classification, predicted HRTF data that represents parameters of a predicted HRTF associated with the user. The one or more processors are configured to output spatial audio data based on audio data and the predicted HRTF data.

### I. FIELD

The present disclosure is generally related to spatialized audio processing.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Modern audio systems, virtual reality (VR) systems, and augmented reality (AR) systems utilize head-related transfer functions (HRTFs) to provide an advanced spatial audio experience. Measuring a user's HRTF can be time consuming and effort intensive. To speed up the process, some systems match users to one of multiple preconfigured HRTFs stored in a database. However, these preconfigured HRTFs may not closely represent some users. Additionally, these HRTFs are developed for a limited number of situations and are not responsive to user feedback.

### III. SUMMARY

According to one implementation of the present disclosure, a device includes a memory configured to store a user classification associated with a user of the device. The user classification associates the user with at least one of a plurality of user classifications. The device also includes one or more processors coupled to the memory. The one or more processors are configured to obtain the user classification. The one or more processors are also configured to extract, from a latent space head-related transfer function (HRTF) encoding based on the user classification, predicted HRTF data that represents parameters of a predicted HRTF associated with the user. The one or more processors are further configured to output spatial audio data based on audio data and the predicted HRTF data.

According to another implementation of the present disclosure, a method includes obtaining, by one or more processors, a user classification associated with a user of a device. The user classification associates the user with at least one of a plurality of user classifications. The method also includes extracting, by the one or more processors, from a latent space head-related transfer function (HRTF) encoding based on the user classification, predicted HRTF data that represents parameters of a predicted HRTF associated with a user. The method further includes outputting, by the one or more processors, spatial audio data based on audio data and the predicted HRTF data.

According to another implementation of the present disclosure, a non-transitory computer-readable medium stores instructions that are executable by one or more processors to cause the one or more processors to obtain a user classification associated with a user of a device. The user classification associates the user with at least one of a plurality of user classifications. The instructions are also executable by the one or more processors to cause the one or more processors to extract from a latent space head-related transfer function (HRTF) encoding based on the user classification, predicted HRTF data that represents parameters of a predicted HRTF associated with a user. The instructions are further executable by the one or more processors to cause the one or more processors to output spatial audio data based on audio data and the predicted HRTF data.

According to another implementation of the present disclosure, an apparatus includes means for obtaining a user classification associated with a user of a device. The user classification associates the user with at least one of a plurality of user classifications. The apparatus also includes means for extracting, from a latent space head-related transfer function (HRTF) encoding based on the user classification, predicted HRTF data that represents parameters of a predicted HRTF associated with the user. The apparatus further includes means for outputting spatial audio data based on audio data and the predicted HRTF data.

According to another implementation of the present disclosure, a device includes a memory configured to store head-related transfer function (HRTF) data associated with a user of the device. The device also includes one or more processors coupled to the memory. The one or more processors are configured to obtain the HRTF data. The one or more processors are also configured to input the HRTF data to a trained encoder to generate encoded HRTF data. The one or more processors are configured to classify the encoded HRTF data to generate a user classification associated with the HRTF data. The one or more processors are further configured to output the user classification that associates the user with at least one candidate user of a plurality of predefined candidate users.

According to another implementation of the present disclosure, a method includes obtaining, by one or more processors, head-related transfer function (HRTF) data associated with a user of a device. The method also includes inputting, by the one or more processors, the HRTF data to a trained encoder to generate encoded HRTF data. The method includes classifying, by the one or more processors, the encoded HRTF data to generate a user classification associated with the HRTF data. The method further includes outputting, by the one or more processors, the user classification that associates the user with at least one candidate user of a plurality of predefined candidate users.

According to another implementation of the present disclosure, a non-transitory computer-readable medium stores instructions that are executable by one or more processors to cause the one or more processors to obtain head-related transfer function (HRTF) data associated with a user of a device. The instructions are also executable by the one or more processors to cause the one or more processors to input the HRTF data to a trained encoder to generate encoded HRTF data. The instructions are executable by the one or more processors to cause the one or more processors to classify the encoded HRTF data to generate a user classification associated with the HRTF data. The instructions are further executable by the one or more processors to cause the one or more processors to output the user classification that associates the user with at least one candidate user of a plurality of predefined candidate users.

According to another implementation of the present disclosure, an apparatus includes means for obtaining head-related transfer function (HRTF) data associated with a user of a device. The apparatus also includes trained encoding means for generating encoded HRTF data based on the HRTF data. The apparatus includes means for classifying the encoded HRTF data to generate a user classification associated with the HRTF data. The apparatus further includes means for outputting the user classification that associates the user with at least one candidate user of a plurality of predefined candidate users.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of particular aspects of a system that includes a device operable to predict individualized head-related transfer function (HRTF) data, in accordance with some examples of the present disclosure.

FIG. 2 is a block diagram of particular aspects of a system that includes multiple devices operable to perform distributed prediction of individualized HRTF data, in accordance with some examples of the present disclosure.

FIG. 3 is a diagram of an illustrative aspect of the individualized HRTF model of FIG. 1 during a training phase, in accordance with some examples of the present disclosure.

FIG. 4 is a diagram of an illustrative aspect of the individualized HRTF model of FIG. 1 during an inference phase, in accordance with some examples of the present disclosure.

FIG. 5 is a diagram of an illustrative aspect of the individualized HRTF model of FIG. 1 during an optimization phase, in accordance with some examples of the present disclosure.

FIG. 6 is a diagram of an illustrative aspect of a system that includes an integrated circuit operable to predict individualized HRTF data, in accordance with some examples of the present disclosure.

FIG. 7 is a diagram of an illustrative aspect of a system that includes a mobile device operable to predict individualized HRTF data, in accordance with some examples of the present disclosure.

FIG. 8 is a diagram of an illustrative aspect of a system that includes a headset device operable to predict individualized HRTF data, in accordance with some examples of the present disclosure.

FIG. 9 is a diagram of an illustrative aspect of a system that includes a portable electronic device, such as a headset, operable to predict individualized HRTF data, in accordance with some examples of the present disclosure.

FIG. 10 is a diagram of an illustrative aspect of a system that includes augmented reality glasses operable to predict individualized HRTF data, in accordance with some examples of the present disclosure.

FIG. 11 is a diagram of an illustrative aspect of a system that includes a wearable device operable to predict of individualized HRTF data, in accordance with some examples of the present disclosure.

FIG. 12 is a diagram of an illustrative aspect of a system that includes earbuds operable to predict of individualized HRTF data, in accordance with some examples of the present disclosure.

FIG. 13 is a diagram of an illustrative aspect of another system that includes a voice-controlled speaker device operable to predict of individualized HRTF data, in accordance with some examples of the present disclosure.

FIG. 14 is a diagram of an illustrative aspect of a system that includes a wearable electronic device operable to predict of individualized HRTF data, in accordance with some examples of the present disclosure.

FIG. 15 is a diagram of an illustrative aspect of a system that includes a vehicle operable to predict individualized HRTF data, in accordance with some examples of the present disclosure.

FIG. 16 is a diagram of a particular implementation of a method of generative predicting individualized HRTF data, in accordance with some examples of the present disclosure.

FIG. 17 is a diagram of a particular implementation of a method of encoding input data for user classification, in accordance with some examples of the present disclosure.

FIG. 18 is a block diagram of a particular illustrative implementation of a device that is operable to predict of individualized HRTF data, in accordance with some examples of the present disclosure.

### V. DETAILED DESCRIPTION

Modern audio devices, earbud devices, headset devices, virtual reality (VR), augmented reality (AR), and extended reality (XR) systems and devices use head-related transfer functions (HRTFs) to provide advanced spatial audio experiences. However, measuring a user's HRTF is time and effort intensive. Some systems address this problem by matching a particular user to an HRTF from a database of pre-measured HRTFs. However, such databases typically have a very limited amount of HRTFs, such that a given user may not be sufficiently represented by the HRTFs in the database. Additionally, even if a user is well-matched to an HRTF in certain conditions, the user may not be sufficiently represented by the HRTF in other conditions. Some systems attempt to optimize a user's HRTF through a time consuming and inconsistent optimization process, which can result in significant time and effort by the user and can use significant power of the devices, thereby shortening the amount of time the devices can be used to provide spatial audio experiences.

Aspects disclosed herein enable audio devices (or other devices) to predict individualized HRTFs (e.g., HRTF parameters) using generative machine learning in a manner that results in individualized HRTFs that better represent users than HRTFs in a preconfigured database and that are generated via a process that is faster, less effort-intensive, and that uses less device power than typical HRTF generation processes. In aspects, an individualized HRTF model (e.g., a generative machine learning (ML) model) is trained to output predicted HRTF data (e.g., predicted HRTF parameters) based on input HRTF data that represents or corresponds to crude HRTF measurements. The individualized HRTF model is designed according to a two-network scheme, such that the individualized HRTF model includes an encoder network and a decoder network that work together to generate individualized (e.g., personalized) HRTFs in real-time or near real-time without look-up tables.

To illustrate, the encoder network is trained to receive HRTF data that represents one or more HRTF parameters of a user and to output, based on the HRTF data, a user classification that associates the user with one or more predefined candidate users associated with pre-measured HRTFs. The HRTF data can include crude HRTF parameter measurements, image data of the user's head or cars, features derived from the image data, audio data representing sound captured during an initialization process, features extracted from the audio data, or a combination thereof, and the user classification can indicate a closest match between the user and a predefined candidate user or a likelihood score of the user to each of multiple predefined candidate users. In some examples, the encoder network includes a trained encoder (e.g., of a variational autoencoder (VAE)) and a trained classifier that are configured to generate encoded HRTF data using a first latent space HRTF encoding and to generate the user classification based on the encoded HRTF data, respectively.

The decoder network is trained to extract predicted HRTF data that represents parameters of a predicted HRTF associated with the user from the user classification. To illustrate, the decoder network can include a trained decoder (e.g., of a conditional variational autoencoder (cVAE)) that is trained to generate predicted HRTF data for one or more conditions based on the user classification and a second latent space HRTF encoding. In aspects, the second latent space HRTF encoding used by the trained decoder is a higher dimension latent space encoding than the first latent space HRTF encoding used by the trained encoder, such that the trained encoder enables quick classification of a user to one or more predetermined candidate users and the trained decoder enables higher accuracy fine-tuning of HRTFs based on conditions such as distance to a sound source, direction to a sound source, environment of the sound source (e.g., as indicated by a room impulse response (RIR)), other conditions, or a combination thereof. In this manner, the individualized HRTF model described herein enables faster convergence and improved consistency due to the encoder network and more accurate and personalized HRTF prediction due to the decoder network, than typical HRTF selection processes that only match a user to a pre-measured HRTF. Thus, the individualized HRTF model described herein can be leveraged to enable systems and devices to provide highly individualized spatial audio experiences for a larger quantity of users. In some examples, user feedback to the spatial audio output can be used to tune (e.g., optimize) parameters of the first HRTF latent space encoding, which can provide improved performance that converges faster, and thus uses less device power, than typically lengthy HRTF optimization processes.

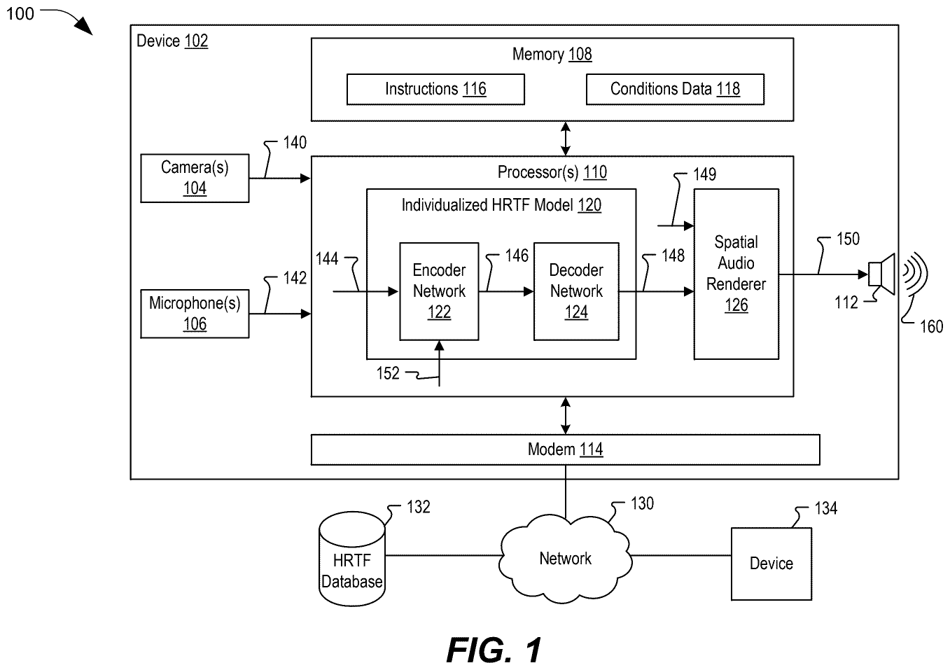

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 110 of FIG. 1), which indicates that in some implementations the device 102 includes a single processor 110 and in other implementations the device 102 includes multiple processors 110. For ease of reference herein, such features are generally introduced as “one or more” features and are subsequently referred to in the singular or optional plural (as indicated by “(s)”) unless aspects related to multiple of the features are being described.

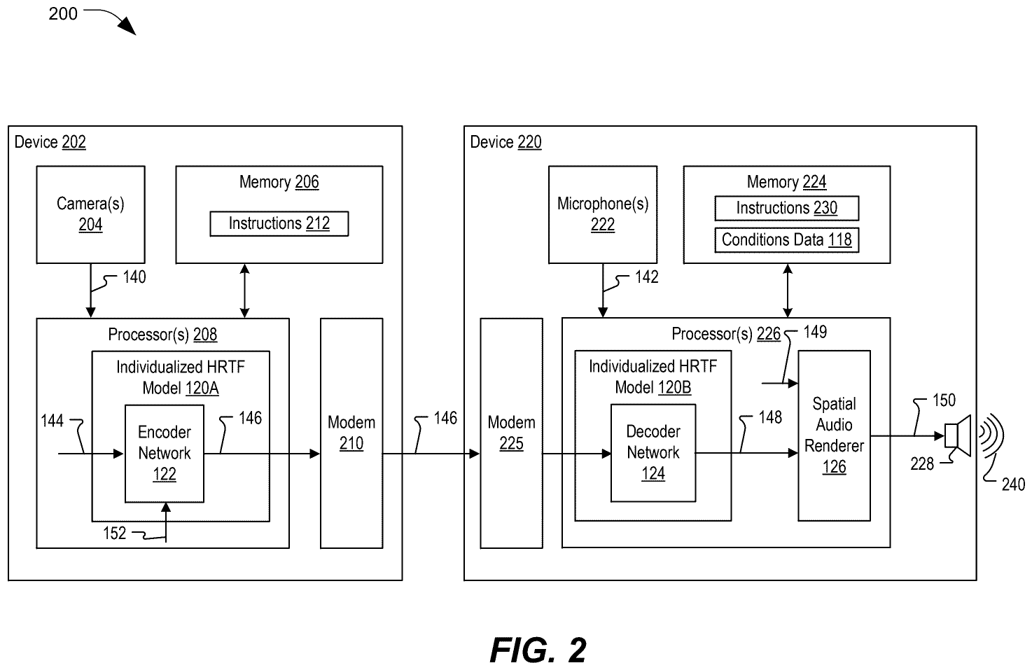

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 2, multiple individualized HRTF models are illustrated and associated with reference numbers 120A and 120B. When referring to a particular one of these multiple individualized HRTF models, such as a multiple individualized HRTF model 120A, the distinguishing letter “A” is used. However, when referring to any arbitrary one of these multiple individualized HRTF models or to these multiple individualized HRTF models as a group, the reference number 120 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows-a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data.” The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

FIG. 1 is a block diagram of particular aspects of a system 100 that includes a device 102 operable to predict of individualized HRTF data, in accordance with some examples of the present disclosure. The device 102 may include an audio device, such as a portable device, a wearable device, a voice-activated speaker device, or a mobile device. The system 100 includes the device 102 coupled to an HRTF database 132 and to another device 134 via a network 130. The network 130 may include one or more of a fifth generation (5G) new radio (NR) cellular network, a Bluetooth® (a registered trademark of BLUETOOTH SIG, INC., Washington) network, an Institute of Electrical and Electronic Engineers (IEEE) 802.11-type network (e.g., Wi-Fi), one or more other wireless networks, or any combination thereof. In some examples, the device 102 is configured to receive HRTF data for a plurality of users from the HRTF database 132 and to receive data from the device 134 to support prediction of individualized HRTF data or to provide spatial audio that is based on the individualized HRTF data to the device 134, as further described below.

The device 102 includes one or more cameras 104 (collectively referred to herein as a camera 104), one or more microphones 106 (collectively referred to herein as a microphone 106), a memory 108, one or more processors 110 (collectively referred to herein as a “processor 110”), speakers 112, and a modem 114. Although the example illustrated in FIG. 1 includes the camera 104, the microphone 106, and the speakers 112, in some embodiments, one or more of the camera 104, the microphone 106, or the speakers 112 are instead distinct from and coupled to the device 102. Although the camera 104, the microphone 106, and the speakers 112 are illustrated in FIG. 1, in some embodiments, one or more of the camera 104, the microphone 106, or the speakers 112 are optional and may be omitted from the device 102, omitted from the system 100, or both.

The camera 104 is coupled to the processor 110 and configured to generate image data 140 that represents images or video captured by the camera 104. In some aspects, the image data 140 can include images or video of a user's ears or head for use in determining parameters of a representative HRTF, as further described herein. The microphone 106 is coupled to the processor 110 and configured to generate input audio data 142 based on sound detected from an audio environment (e.g., an ambient environment of the device 102). In some aspects, the microphone 106 includes a first microphone (e.g., a feedforward microphone), a second microphone (e.g., a feedback microphone), a third microphone (e.g., a voice microphone), or a combination thereof. The sound can include speech, sounds of interest to a user, ambient sound, noise, other sounds, or a combination thereof. In some aspects, the input audio data 142 can represent an audio signal that is captured during a process to generate HRTF parameters for a user of the device 102, as further described herein.

The memory 108 is configured to store instructions 116 and conditions data 118. The instructions 116, when executed by the processor 110, cause the processor 110 to perform one or more operations as described herein. The conditions data 118 represents one or more conditions associated with a sound source for which spatialized audio data is to be generated. For example, the conditions data 118 can represent a distance between the device 102 and the sound source, a direction of the sound source with respect to the device 102, a room impulse response function (RIR) associated with a room in which the sound source is located, other conditions, or a combination thereof. According to some aspects, the conditions data 118 is generated by an audio application that generates spatial audio data associated with a sound source, such as a video game, an AR application, a VR application, an XR application, a music application, a videoconference or teleconference application, or the like. Additionally, or alternatively, the conditions data 118 may be determined during an initial HRTF generation process or received from another device, such as the device 134.

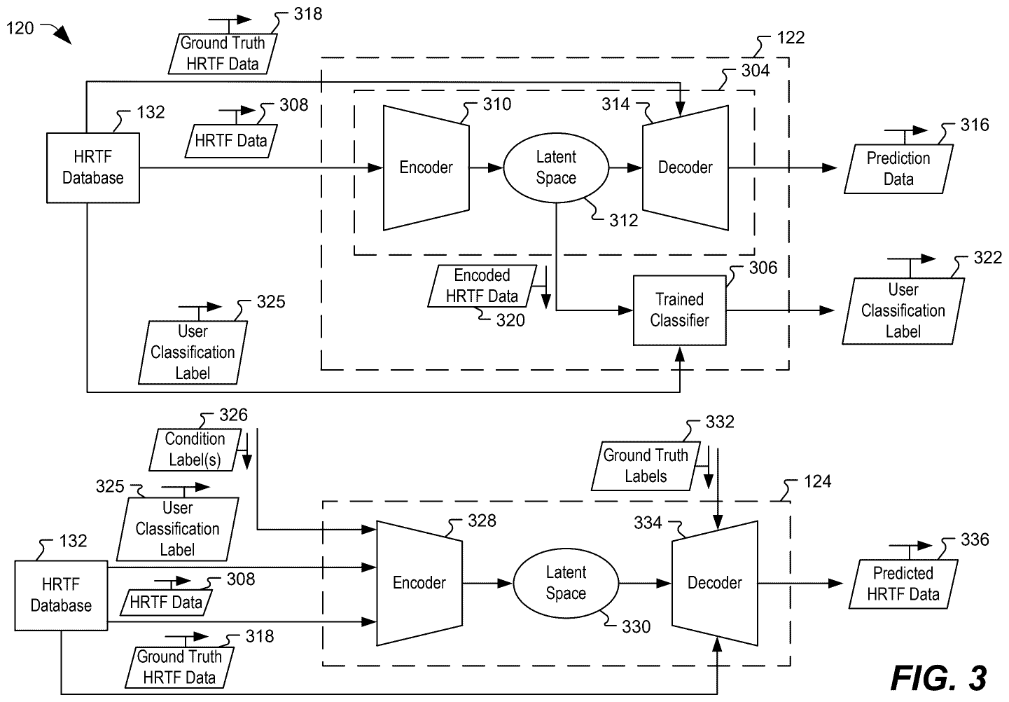

The processor 110 includes an individualized HRTF model 120. In the example illustrated in FIG. 1, the individualized HRTF model 120 includes an encoder network 122 and an decoder network 124. In other examples, as further described with reference to FIG. 2, the individualized HRTF model 120 includes either the encoder network 122 or the decoder network 124, but not both. The individualized HRTF model 120 may be trained at the device 102, such as during a training phase further described herein with reference to FIG. 3, or the individualized HRTF model 120 may be trained at another device (e.g., a server, a cloud-based ML service provider, etc.) and parameters that represent the trained ML model may be received by the device 102 and used to instantiate a local copy of the individualized HRTF model 120

The encoder network 122 is configured to receive input data that represents HRTF parameters of a user of the device 102 and to generate a classification output that associates the user with at least one candidate user of a plurality of predefined candidate users. For example, the encoder network 122 may be configured to receive HRTF data 144 associated with a user of the device 102 and to generate a user classification 146 associated with the HRTF data 144. Although referred to as HRTF data, the HRTF data 144 may include a set of HRTF parameters (e.g., for one or more specific conditions, such as a particular distance or direction to a sound source) or a subset of HRTF parameters, or the HRTF data 144 may include different types of data that indicate or can be used to derive HRTF parameters. To illustrate, the HRTF data 144 may include a set of measurements of the user's head or ears from which one or more HRTF parameters can be derived. As another example, the HRTF data 144 may include the image data 140 from the camera 104, with the image data 140 representing images of the user's head or ears from which measurements, and thus HRTF parameters, can be derived. As another example, the HRTF data 144 may include the input audio data 142 from the microphone 106, with the input audio data 142 representing an audio signal that is captured during an audio output by a sound source having known conditions (e.g., direction, distance, RIR, etc.), and from which one or more HRTF parameters can be derived. Thus, the HRTF data 144 may be obtained during an initial setup process, but because the HRTF data 144 can include or be derived from the above-described types of data, the initial setup process may be faster and less burdensome on a user than a typical time consuming and effort intensive HRTF measuring process, such as one performed using a substantial number of repeated numbers or a trained expert.

In some aspects, the encoder network 122 includes a trained encoder and a trained classifier that are configured to support the generation of the user classification 146. For example, the encoder network 122 may include a generative ML model (e.g., a trained encoder), which in some embodiments is part of a variational autoencoder (VAE), that is trained to encode the HRTF data into a first latent space HRTF encoding, as further described herein with reference to FIG. 3. The encoder network 122 may also include a trained classifier that is trained to classify encoded HRTF data as being associated with one or more candidate users of multiple predefined candidate users. The trained classifier may include a deep neural network (DNN) or other type of classifier that is trained using supervised learning to predict a candidate user (e.g., from the HRTF database 132) that most closely matches input encoded HRTF data.

To illustrate, the HRTF database 132 may include candidate user HRTF data that represents one or more HRTF functions (or parameters thereof) for one or more candidate users. For example, prior to deploying the device 102, a more time and effort intensive HRTF measuring process may be performed on multiple candidate users to generate sets of HRTF functions (or parameters thereof) for one or more conditions. However, the candidate user HRTF data stored in the HRTF database 132 may not be sufficiently individualized to provide the desired spatial audio experience to at least some users. For example, a particular user may have different HRTF parameters due to differences in head and car shape, due to differences in distance, direction, room conditions, or the like as compared to during the HRTF measuring procedure, or other reasons. For this reason, merely matching the HRTF data 144 to the closest HRTF parameters of the multiple candidate users may not provide a sufficiently individualized spatial audio experience to the user. Instead of outputting HRTF data that is associated with the user classification 146, the user classification 146 is provided to the decoder network 124 for additional operations to generate more refined and individualized HRTF parameters.

The decoder network 124 is configured to predict one or more individualized HRTF parameters associated with a user of the device 102 based on a user classification associated with the user. For example, the decoder network 124 may be configured to extract predicted HRTF data 148 from a latent space HRTF encoding based on the user classification 146. The predicted HRTF data 148 represents one or more predicted HRTF parameters that are individualized to the user and that enable generation of spatial audio associated with one or more sound sources. In some aspects, the decoder network 124 includes a generative ML model (e.g., a trained decoder), which in some embodiments is part of a conditional VAE (cVAE), that is trained to decode the predicted HRTF data 148 from a second latent space HRTF encoding, as further described herein with reference to FIG. 3. Additionally, the trained decoder may be trained on various conditions training data to extract the predicted HRTF data 148 based on the conditions data 118. To illustrate, the conditions data 118 may represent a particular distance between the device 102 and a sound source for which spatial audio is to be generated, as a non-limiting example, and although HRTF parameters associated with the candidate user indicated by the user classification 146 are stored at the HRTF database 132, the HRTF parameters at the HRTF database 132 for the particular candidate user may have been measured for sound sources having significantly different distances to the user and thus are not sufficiently representative of the sound source in this instance. However, by increasing the training dataset for the trained classifier to include conditions such as direction, distance, and the like, either for the particular candidate user or for others, the decoder can be trained to predict HRTF parameters that more closely align with the particular conditions when provided with the conditions data 118 as input. The predicted HRTF data 148 is output by the individualized HRTF model 120 for use in generating spatial audio data.

The processor 110 also includes a spatial audio renderer 126 that is configured to output spatial audio data 150 based on audio data 149 and the predicted HRTF data 148. For example, the spatial audio renderer 126 may be configured to binauralize the audio data 149 based on the predicted HRTF data 148 (e.g., one or more HRTF parameters or HRTFs) to generate pose-adjusted binaural audio signals (e.g., the spatial audio data 150) for playback by the speakers 112 to provide sound that is perceived by the user as having a two-dimensional (2D) or three-dimensional (3D) sound field or that is output by a particularly located sound source. The spatial audio renderer 126, or a portion thereof, may be implemented by the processor 110 executing instructions (e.g., software), dedicated hardware (e.g., circuitry), a combination thereof.

The speaker 112 is coupled to the processor 110 and configured to output audio sound 160. To illustrate, the audio sound 160 output by the speaker 112 may be based on an output of the spatial audio renderer 126, such that the audio sound 160 is a spatialized audio sound that is based on the spatial audio data 150 and that is perceptible to a user as coming from a sound source having a particular direction and distance from the user. The modem 114 is coupled to the processor 110 and configured to send data to, receive data from, or both, the network 130, such as to the HRTF database 132 or the device 134. In aspects, the modem 114 is configured to send the predicted HRTF data 148 or the spatial audio data 150 to the device 134. Additionally, or alternatively, the modem 114 may be configured to receive candidate user HRTF data from the HRTF database 132, such as during a training phase as further described herein with reference to FIG. 3.

During operation of the device 102, the processor 110 may obtain the HRTF data 144 for input to the individualized HRTF model 120 (e.g., to the encoder network 122). The HRTF data 144 represents, indicates, or may be used to derive, one or more HRTF parameters of a user of the device 102. In some examples, the HRTF data 144 includes measurement data representing one or more measurements of an ear of the user, one or more measurements of the head of the user, one or more sample HRTF measurements that have already been measured, or a combination thereof. For example, the HRTF data 144 may be entered by the user (e.g., via a user interface that prompts the user to provide measurements or pre-measured HRTF measurements) or received from another device (e.g., via the modem 114). Additionally, or alternatively, the HRTF data 144 may include image data that represents one or more images of an ear of the user or the head of the user. For example, the user may take pictures of their head or ear(s) with the camera 104, and the image data 140 may be included in the HRTF data 144. Additionally, or alternatively, the HRTF data 144 may include audio data that represents one or more sounds captured during an HRTF initialization process. For example, the device 102 may cause one or more other devices or components to output sounds that are captured by the microphone 106, and the input audio data 142 may be included in the HRTF data 144. Although not shown in FIG. 1, the HRTF data 144 may be stored at the memory 108 prior to being input to the individualized HRTF model 120.

The encoder network 122 may generate the user classification 146 associated with the HRTF data 144. The user classification 146 associates the user of the device 102 with at least one candidate user of multiple predefined candidate users. For example, the HRTF database 132 may include HRTFs for multiple candidate users that are pre-measured and stored at the HRTF database 132 for use by multiple devices. The user classification 146 may indicate one or more of the candidate users that are associated with the user based on the HRTF data 144. As an example, the user classification 146 may indicate a closest matching candidate user to the user based on the HRTF data 144. To illustrate, the user classification 146 may include a one-hot vector with each element of the vector corresponding to one of the candidate users. As another example, the user classification 146 may indicate a likelihood score for each of one or more candidate users. To illustrate, the user classification 146 may include a vector of likelihood scores with each element representing a likelihood of a match between the user of the device 102 and the corresponding candidate user. In such an example, the user classification includes a first score associated with a first user classification of a plurality of user classifications (e.g., a first candidate user) and a second score associated with a second user classification (e.g., a second candidate user) of the plurality of user classifications.

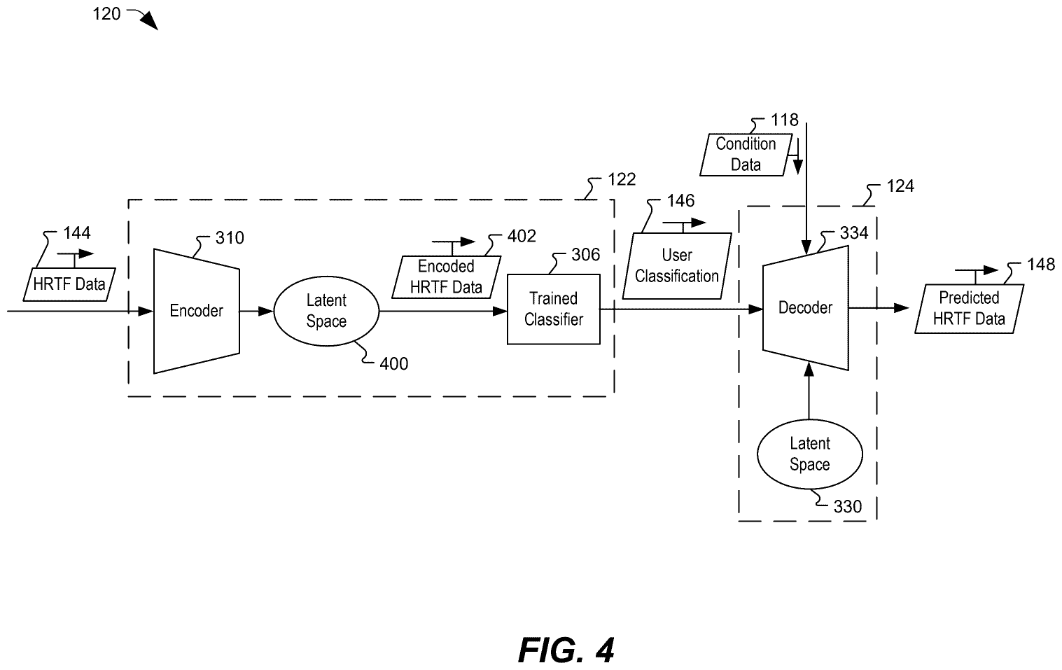

To generate the user classification 146, the encoder network 122 may encode the HRTF data 144 and then classify the encoded HRTF data, resulting in the user classification 146. In aspects, the encoder network 122 includes a trained encoder and a trained classifier, and the encoder network 122 may input the HRTF data 144 to the trained encoder to generate encoded HRTF data that is input to the trained classifier to generate the user classification 146, as further described with reference to FIG. 4. In some examples, the trained encoder is included in a variational autoencoder (VAE) and is trained to generate the encoded HRTF data based on a first latent space HRTF encoding, and the trained classifier includes a deep neural network (DNN) or another type of classifier model that is trained to classify the encoded HRTF data as one or more of multiple user classifications. The encoder network 122 may output the user classification 146 to the decoder network 124. Although not shown in FIG. 1, the user classification 146 may be stored at the memory 108 after being output by the encoder network 122.

The decoder network 124 may extract, based on the user classification 146, the predicted HRTF data 148 that represents parameters of a predicted HRTF associated with the user of the device 102. For example, the predicted HRTF data 148 may include parameters of an HRTF that is more personalized (e.g., individualized) to the user than the HRTFs in the HRTF database 132, for example being adjusted based on one or more conditions indicated by the conditions data 118. In aspects, the decoder network 124 includes a trained decoder, and the decoder network 124 may input the user classification 146 to the trained decoder to generate the predicted HRTF data 148, as further described with reference to FIG. 4. In some examples, the trained decoder is included in a cVAE and is trained to generate the predicted HRTF data 148 based on at least the user classification 146 and a second latent space HRTF encoding. In some such examples, the first latent space HRTF encoding associated with the encoder network 122 (e.g., the trained encoder) is associated with a first feature space having a first number of dimensions, and the second latent space HRTF encoding associated with the decoder network 124 (e.g., the trained decoder) is associated with a second feature space having a second number of dimensions that is greater than the first number. Stated another way, the first latent space HRTF encoding is a lower-dimensional feature space than the second latent space HRTF encoding, as further described herein with reference to FIG. 3.

The decoder network 124 may extract the predicted HRTF data 148 based on the user classification 146 and the conditions data 118. To illustrate, the conditions data 118 may indicate one or more conditions that are relevant to fine-tuning predicted HRTFs to be more individualized to a user. Examples of such conditions include a direction from the device 102 to a sound source (e.g., a sound source that is outputting a sound that corresponds to spatial audio to be generated by the device 102, such as a physical sound source or a virtual sound source in a video game or a VR environment), distance between the device 102 and the sound source, characteristics of an environment in which the sound source or the device 102 is located (which may be indicated by a room impulse response function (RIR) of a room in which the device 102 or the sound source is located), other conditions, or a combination thereof. In such examples, the conditions data 118 can include direction data that indicates a direction (e.g., from the device 102) of the sound source that corresponds to spatial audio data, distance data that indicates a distance between the device 102 and the sound source, room data that corresponds to an RIR of a room in which the device 102 or the sound source is located, other data, or a combination thereof, and the conditions indicated by the conditions data 118 may be input as conditions to the cVAE (e.g., the trained decoder) included in the decoder network 124 to generate the predicted HRTF data 148. In some examples, the conditions data 118 includes conditions for a set of directions, a set of distances, a set of other conditions, or a combination thereof, such that the predicted HRTF data 148 represents HRTFs for all known or expected sets of directions, distances, or other conditions. Alternatively, the conditions data 118 can include conditions associated with one or more particular sound sources for which audio is being generated instead of a set of other conditions, such that the HRTF data 148 represents HRTFs that are generated “on the fly” as audio from different sound sources (e.g., at different directions, distances, etc.) is generated. The predicted HRTF data 148 may be stored at the memory 108 prior to being used to generate spatial audio data.

After the individualized HRTF model 120 (e.g., the decoder network 124) outputs the predicted HRTF data 148, the processor 110 may provide the predicted HRTF data 148 and the audio data 149 as input to the spatial audio renderer 126 to generate the spatial audio data 150. The audio data 149 may include audio data that is captured by the device 102, audio data that is received from another device, audio data that is generated by an application being executed by the device 102, audio data stored at the memory 108, streaming audio data, other audio data, or a combination thereof. As an example, the audio data 149 may include the input audio data 142 captured by the microphone 106. Additionally, or alternatively, the audio data 149 may be generated by an application executed by the processor 110, such as an AR application, a VR application, an XR application, a video game, or another type of application that generates spatial audio based on virtual audio sources. Additionally, or alternatively, the audio data 149 may be received from the device 134 (e.g., via the modem 114) for spatializing and playback by the device 102. The spatial audio renderer 126 may render the spatial audio data 150 by applying the HRTF(s) indicated by the predicted HRTF data 148 to the audio data 149, and the spatial audio data 150 may be output by the speakers 112 as the audio sound 160.

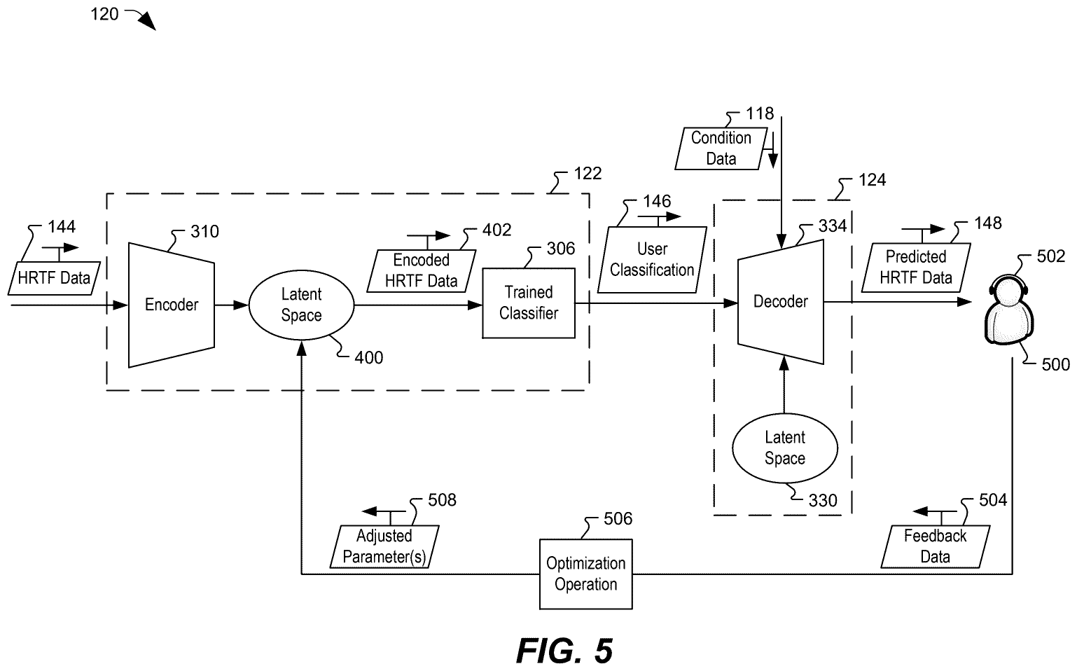

In some examples, the processor 110 may be configured to prompt the user for feedback regarding the spatial audio data 150, and the user may provide feedback data 152 that is used to improve performance of the individualized HRTF model 120 (e.g., the encoder network 122). To illustrate, the processor 110 may perform an adjustment or optimization operation on one or more parameters associated with the trained encoder (e.g., the first latent space HRTF encoding) included in the encoder network 122 based on the feedback data 152, as further described herein with reference to FIG. 5. In some examples, the device 102 may include a user interface that is configured to request and receive the feedback data 152 from the user. For example, a display screen or a touch screen may display a user interface (UI) that enables the user to indicate perceived directions or locations of one or more spatial sounds, user ratings associated with the spatial sounds, other feedback information, or a combination thereof, that is received as the feedback data 152. As another example, the camera 104 may be configured to track the user's gaze to determine the perceived location or direction of the spatial sounds, and in such an example, the image data 140 may be included as the feedback data 152. As another example, the microphone 106 may be configured to capture user speech that includes responses to questions, and in such an example, the input audio data 142 may be included as the feedback data 152. As another example, the device 102 may be a headset device that includes one or more motion sensors, and motion data that corresponds to motion tracking of the user's head may be included as the feedback data 152.

According to one implementation of the present disclosure, the device 102 includes the memory 108 that is configured to store the user classification 146 associated with a user of the device 102. The user classification 146 associates the user with at least one of a plurality of user classifications (e.g., stored at the HRTF database 132). The device 102 also includes one or more processors (e.g., the processor 110) coupled to the memory 108. The one or more processors are configured to obtain the user classification 146. The one or more processors are also configured to extract, from a latent space HRTF encoding (e.g., included in the decoder network 124) based on the user classification 146, the predicted HRTF data 148 that represents parameters of a predicted HRTF associated with the user. The one or more processors are further configured to output the spatial audio data 150 based on the audio data 149 and the predicted HRTF data 148.

According to another implementation of the present disclosure, the device 102 includes the memory 108 that is configured to store the HRTF data 144 (e.g., input data) associated with a user of the device 102. The device 102 also includes one or more processors (e.g., the processor 110) coupled to the memory 108. The one or more processors are configured to obtain the HRTF data 144. The one or more processors are also configured to input the HRTF data 144 to a trained encoder (e.g., included in the encoder network 122) to generate encoded HRTF data. The one or more processors are configured to classify the encoded HRTF data to generate a user classification 146 associated with the HRTF data 144. The one or more processors are further configured to output the user classification 146 that associates the user with at least one candidate user of a plurality of predefined candidate users (e.g., stored at the HRTF database 132).

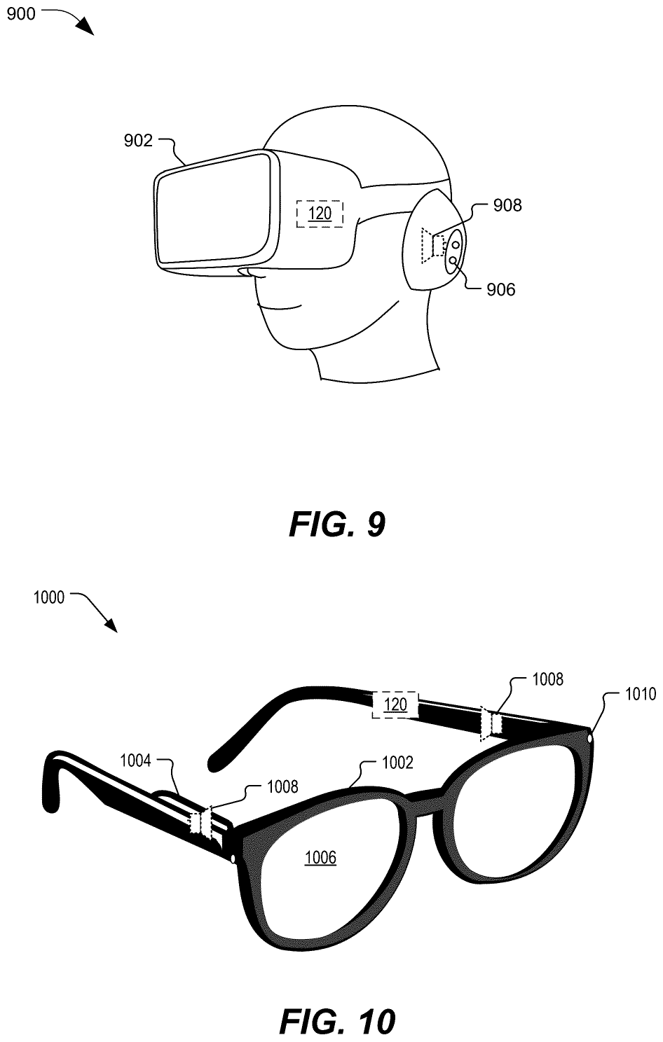

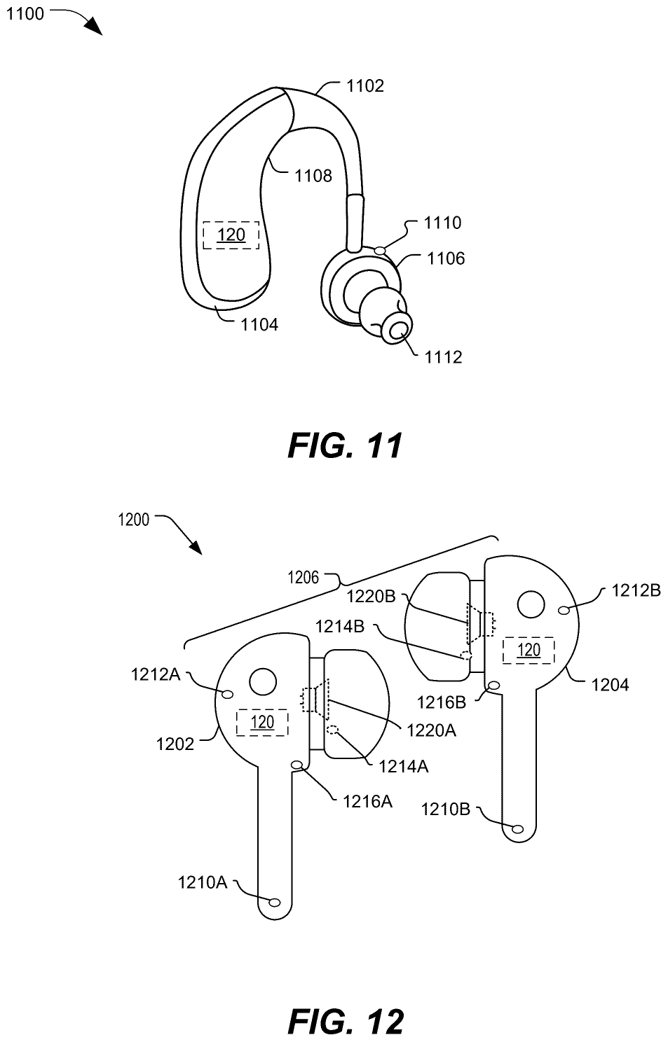

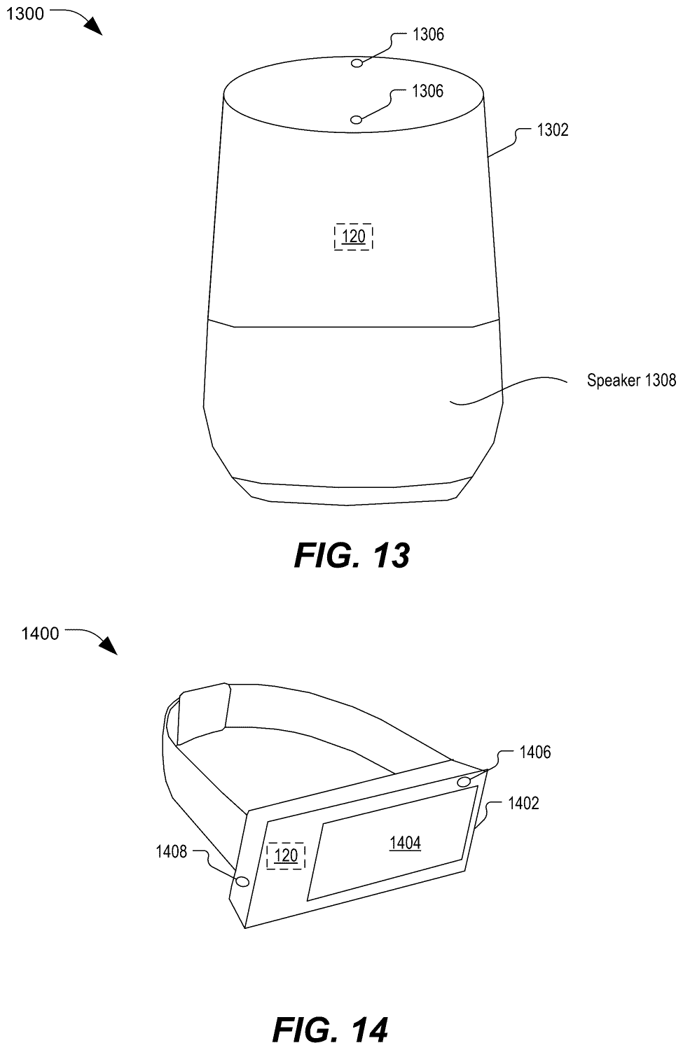

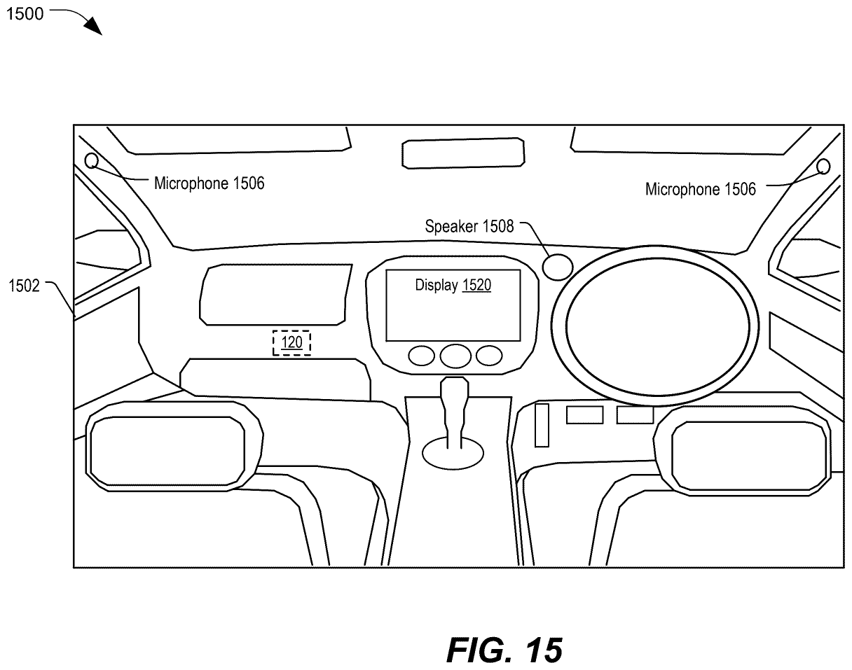

In some examples, the device 102 corresponds to or is included in one of various types of devices. In an illustrative example, the processor 110 is integrated in a headset device, as described further with reference to FIG. 8. In other examples, the processor 110 is integrated in at least one of a mobile phone or a tablet computer device, as described with reference to FIG. 7, a wearable electronic device, as described with reference to FIG. 14, a voice-controlled speaker system, as described with reference to FIG. 13, a virtual reality, mixed reality, or augmented reality headset, as described with reference to FIG. 9, a mixed reality or augmented reality glasses device, as described with reference to FIG. 10, earbuds, as described with reference to FIG. 12, or a hearing aid device, as described with reference to FIG. 11. In another illustrative example, the processor 110 is integrated into a vehicle, such as described further with reference to FIG. 15.

One technical advantage of implementing the device 102 as described above is that the device 102 may generate the predicted HRTF data 148, which is used to enable output of the audio sound 160 (e.g., spatial audio) that is more individualized to a user of the device 102 than typical spatial audio systems that merely match the user to one of a small set of existing HRTFs. To illustrate, the encoder network 122 outputs the user classification 146 that associates the user with one or more predefined candidate users of the HRTF database 132 (and associated HRTFs). However, the decoder network 124 then extracts the predicted HRTF data 148 from the user classification 146, resulting in finer tuned, more individualized HRTF parameters for one or more conditions indicated by the conditions data 118. As such, the user experience of the user of the device 102 when listening to the audio sound 160 is improved as compared to generating the audio sound based on an HRTF in the HRTF database 132. Additionally, the encoder network 122 can be fine-tuned (e.g., one or more parameters of the latent space HRTF encoding used by the trained encoder of the encoder network 122 can be adjusted or optimized) based on the feedback data 152 to improve the initial user classification performed by the encoder network 122 in a manner that converges faster, and uses less battery of the device 102, than the time and effort-intensive optimization processes performed by other HRTF measurement systems.

Although the device 102 is illustrated and described as being coupled to the HRTF database 132 and the device 134 via the network 130, in other examples, the HRTF database 132, the device 134, or both, could be integrated within the device 102. For example, the HRTF database 132 may be stored at the memory 108 instead of being coupled to the device 102 via the network 130. As another example, functionality of the device 134 may be performed by the processor 110 executing the instructions 116 instead of the device 134 being a distinct, external device.

Although the device 102 is illustrated and described as including the camera 104, in other examples, the camera 104 is omitted from the device 102. In such examples, the HRTF data 144 may be based on the input audio data 142 from the microphone 106 (e.g., one or more microphones positioned at or within the user's ears), user response data (e.g., user-entered measurements of ears or head or a subset of pre-measured HRTF parameters) received via a user interface, data received from another device (e.g., the device 134), or a combination thereof.

Although the device 102 is illustrated and described as including the microphone 106, in other examples, the microphone 106 is omitted from the device 102. In such examples, the HRTF data 144 may be based on the image data 140 (e.g., images of the user's ears or head) from the camera 104, user response data (e.g., user-entered measurements of ears or head or a subset of pre-measured HRTF parameters) received via a user interface, data received from another device (e.g., the device 134), or a combination thereof. Additionally, or alternatively, in such examples the audio data 149 may include audio that is captured from other sources than the device 102, such as another device (e.g., the device 134), audio that is stored at the memory 108, streaming audio, or audio that is generated at an application executed by the device 102 (e.g., a video game, an AR application, a VR application, an XR application, a multimedia application, or the like).

Although the device 102 is illustrated and described as including the speakers 112, in other examples, the speakers 112 are omitted from the device 102. In such examples, the spatial audio data 150 may be sent via wireless or wired transmission to playback speakers (e.g., earbuds, a headset, etc.) that are external to the device 102. Additionally, or alternatively, the device 102 may be a server or other centralized component that generates the spatial audio data 150 for various network devices and sends the spatial audio data 150 to the devices (e.g., the device 134) via the network 130.

FIG. 2 is a block diagram of particular aspects of a system 200 that includes multiple devices operable to perform distributed prediction of individualized HRTF data, in accordance with some examples of the present disclosure. In the example depicted in FIG. 2, the system 200 includes a device 202 that is communicatively coupled to a device 220. Although not shown, the device 202 may be coupled to the device 220, or to one or more other entities such as an HRTF database, via a network (e.g., the network 130 of FIG. 1). In some examples, the device 202 includes or corresponds to a mobile device and the device 220 includes or corresponds to a headset device or earbud device. In such examples, the device 202 may be configured to determine (e.g., generate) HRTF data associated with a user of the device 220, such as by capturing images of the user's head or ears, receiving user input via a user interface, receiving HRTF data or audio data associated with an HRTF initialization process from another device (e.g., the device 220 or a different device) via wireless communication, or a combination thereof.

The device 202 includes one or more cameras 204 (collectively referred to herein as a camera 204), a memory 206, one or more processors 208 (collectively referred to herein as a “processor 208”), and a modem 210. The camera 204, the memory 206, the processor 208, and the modem 210 are configured similarly to the camera 104, the memory 108, the processor 110, and the modem 114 described with reference to FIG. 1, respectively. The memory 206 may include instructions 212 that, when executed by the processor 208, cause the device 202 to perform the operations described herein. In the example shown in FIG. 2, the processor 208 includes an individualized HRTF model 120A that includes the encoder network 122 but does not include the decoder network 124. Although not shown in FIG. 2, in some examples, the device 202 includes one or more microphones configured to capture user speech for detecting user commands, the HRTF data 144 may be stored in the memory 206 prior to being input to the individualized HRTF model 120A, or both. Additionally, or alternatively, the camera 204, the modem 210, or both are optional and may be omitted from the device 202, omitted from the system 200, or both, as described above with reference to FIG. 1.

The device 220 includes one or more microphones 222 (collectively referred to herein as a microphone 222), a memory 224, a modem 225, one or more processors 226 (collectively referred to herein as a “processor 226”), and speakers 228. The microphone 222, the memory 224, modem 225, the processor 226, and the speakers 228 are configured similarly to the microphone 106, the memory 108, the modem 114, the processor 110, and the speakers 112 described with reference to FIG. 1, respectively. The memory 224 may include instructions 230 that, when executed by the processor 226, cause the device 220 to perform the operations described herein. The memory 224 may also include the conditions data 118. The processor 226 includes an individualized HRTF model 120B and the spatial audio renderer 126. In the example shown in FIG. 2, the individualized HRTF model 120B includes the decoder network 124 but does not include the encoder network 122. Although shown as including the modem 225, in other examples, the modem 225 is replaced in the device 220 with a different type of wireless communication interface to enable wireless communications with the device 202, the memory 224 stores the user classification 146, or both. It should be appreciated that the communications between the device 202 and the device 220 are not limited to any particular type of wireless or wired communication. Additionally, or alternatively, one or more of the microphone 222, the modem 225, or the speakers 228 are optional and may be omitted from the device 220, omitted from the system 200, or both, as described above with reference to FIG. 1.

During operation of the device 202 and the device 220, the processor 208 obtains the HRTF data 144 and inputs the HRTF data 144 to the individualized HRTF model 120A (e.g., to the encoder network 122), and the encoder network 122 generates the user classification 146 based on the HRTF data 144, as described above with reference to FIG. 1. In some examples, the HRTF data 144 is input via a user interface, received from another device (e.g., the input audio data 142 may be received from the device 220), or includes the image data 140. After generation of the user classification 146, the device 202 transmits the user classification 146 to the device 220 (e.g., via the modem 210). The device 220 receives the user classification 146 (e.g., via the modem 225), and the processor 226 inputs the user classification 146 to the individualized HRTF model 120B (e.g., the decoder network 124), and the decoder network 124 extracts the predicted HRTF data 148 from the user classification, as described above with reference to FIG. 1. In some examples, the processor 226 further inputs the conditions data 118 to the decoder network 124 to enable generation of the predicted HRTF data 148. The conditions data 118 can include one or more set of conditions or one or more conditions associated with a sound source for which spatial audio is to be generated, as described above with reference to FIG. 1. The predicted HRTF data 148 may be stored at the memory 224. After generation of the predicted HRTF data 148, the processor 226 may input the predicted HRTF data 148 and the audio data 149 to the spatial audio renderer 126 to cause the spatial audio renderer 126 to render the spatial audio data 150 based on the audio data 149 and the predicted HRTF data 148. The spatial audio data 150 may be output via the speakers 228 as an audio sound 240 (which may include or correspond to the audio sound 160 of FIG. 1). In some examples, the user of the device 220 (or a user of both devices 202 and 220) may provide the feedback data 152 (e.g., via a UI of the device 202, the camera 104, the microphone 106, or in other manners, as described above with reference to FIG. 1), and the processor 208 may perform an adjustment or optimization operation on one or more parameters of the encoder network 122 (e.g., the trained encoder and the associated first latent space HRTF encoding), as further described herein with reference to FIG. 5.

Thus, FIG. 2 represents an example in which the HRTF prediction process is distributed across multiple devices, e.g., the device 202 and the device 220. In such an example, one device includes the encoder network 122 and the other device includes the decoder network 124, and the user classification 146 is transmitted between the devices. To illustrate, the device 202 uses the encoder network 122 to generate the user classification 146 that is transmitted to the device 220, and the device 220 uses the decoder network 124 to generate the predicted HRTF data 148 that is used to generate the spatial audio data 150 and output the audio sound 240 that is individualized to a user of the device 220 (or a user of both devices 202 and 220). As a result of the two-network design of the individualized HRTF model 120, the faster and consistent operations to classify a user based on input HRTF data can be performed at a first device and the more processor-intensive fine-tuning of the HRTF parameters can be performed by a second device.

FIGS. 3-5 are diagrams of illustrative aspects of the individualized HRTF model 120 of FIG. 1 during various phases of operation, in accordance with some examples of the present disclosure. FIG. 3 depicts the individualized HRTF model 120 during a training phase. FIG. 4 depicts the individualized HRTF model 120 during an inference phase. FIG. 5 depicts the individualized HRTF model 120 during an optimization phase. Some elements of the individualized HRTF model 120 that are illustrated in FIG. 5 may not be in operation during the optimization phase.

Referring to FIG. 3, the individualized HRTF model 120 includes the encoder network 122 (e.g., a first generative ML network) and the decoder network 124 (e.g., a second generative ML network). The encoder network 122 includes a variational autoencoder (VAE) 304 and a trained classifier 306. The VAE 304 includes a first trained encoder 310 that is trained to encode input data into a first latent space HRTF encoding 312 and a first trained decoder 314 that is configured to decode samples of the first latent space HRTF encoding 312 to generate prediction data 316 that represents a set of predicted or estimated HRTF parameters or a prediction of a similar input (e.g., if the input data is another type of data).

The trained classifier 306 is trained to classify encoded HRTF data 320 (e.g., a vector representing the first latent space HRTF encoding 312) from the first latent space HRTF encoding 312 as one or more of a plurality of user classifications. In some examples, the trained classifier 306 includes a deep neural network (DNN) or another type of classifier, such as another type of neural network, a support vector machine (SVM), or another type of ML model. Unlike the VAE 304, which is a generative ML model, the trained classifier 306 is a classifier that is trained using supervised training to generate an output that indicates a predicted classification (e.g., of one or more candidate users) based on a user classification.

The decoder network 124 includes cVAE. The cVAE includes a second trained encoder 328 that is trained to encode input HRTF data and an associated user classification, in addition to one or more condition labels 326 that represent input conditions. The input conditions may include a direction (e.g., of a sound source), a distance (e.g., of the sound source), a depth of a room, other conditions, or a combination thereof, into a second latent space HRTF encoding 330. The cVAE (e.g., the decoder network 124) also includes a second trained decoder 334 that is configured to decode samples of the second latent space HRTF encoding 330 and one or more input conditions to generate predicted HRTF data 336 that represents a set of predicted or estimated HRTF parameters.

During the training phase of FIG. 3, the encoder network 122 and the decoder network 124 may be trained based on preconfigured HRTF data associated with multiple users, such as stored in the HRTF database 132. For example, the HRTF database 132 may store sets of HRTF parameters associated with multiple users (e.g., predetermined candidate users) that were tested during an initial testing process, and the HRTF parameters for each candidate user may include HRTF parameters for multiple directions (e.g., of a sound source), multiple distances (e.g., between the user and the sound source), multiple depths of rooms (e.g., rooms in which the HRTF parameters are determined) or multiple room impulse response (RIR) functions, other conditions, or a combination thereof. Additionally, the HRTF database 132 may store representative information that can be mapped to the candidate users and that is indicative of the HRTF parameters, such as head and/or ear measurements, image data representing the candidate users' heads and/or ears, or the like. For each candidate user in the HRTF database 132, HRTF data 308 may be input to the first trained encoder 310 to generate the first latent space HRTF encoding 312, and the first trained decoder 314 may sample the first latent space HRTF encoding 312 to generate the prediction data 316. The HRTF data 308 may also be provided as ground truth HRTF data 318 to be used to train the VAE 304 to generate the first latent space HRTF encoding 312 that represents the various HRTF data 308 in fewer dimensions than the HRTF data 308 and to minimize an error between the prediction data 316 and the ground truth HRTF data 318.

Also during the training phase, the trained classifier 306 may be trained to classify vectors from the first latent space HRTF encoding 312 that correspond to input HRTF parameters as being associated with one or more of the candidate users associated with the HRTF database 132. For example, the trained classifier 306 may output a user classification 322 that indicates one or more candidate users (e.g., from the HRTF database 132) that are associated with the encoded HRTF data 320 (e.g., an encoded vector input) from the first latent space HRTF encoding 312. In some examples, the user classification 322 includes one or more probability values that indicate a probability that the encoded vector is associated with a corresponding candidate user from the multiple candidate users associated with the HRTF database 132. The trained classifier 306 may be trained using training data that includes an encoded vector and a user classification label 325 (e.g., a one-hot encoded ground truth vector) that indicates a corresponding candidate user associated with the HRTF data 308 and the encoded vector.

Also during the training phase, the decoder network 124 (e.g., the cVAE) may be trained to generate the predicted HRTF data 336 based on the preconfigured HRTF data of the HRTF database 132. Similar to as described for the VAE 304, for each candidate user in the HRTF database 132, the HRTF data 308 may be input, along with conditions including the user classification label 325 that is associated with the HRTF data 308 and the condition label(s) 326, such as a direction label (e.g., a label indicating azimuth and elevation) of a sound source associated with the HRTF data 308, to the second trained encoder 328 to generate the second latent space HRTF encoding 330. The second trained decoder 334 may sample the second latent space HRTF encoding 330 to generate the predicted HRTF data 336. In other examples, the condition label(s) 326 include additional condition labels, such as a distance label associated with a distance to the sound source, a depth label associated with a depth of a room associated with the HRTF data 308 (e.g., based on an RIR), other conditions, or a combination thereof.

The user classification label 325 and the condition label(s) 326 may also be provided as ground truth condition labels 332 to the second trained decoder 334 to be used to train the decoder network 124 to generate the second latent space HRTF encoding 330 and to minimize an error between the predicted HRTF data 336 and the ground truth HRTF data 318. In addition to representing the various HRTF data 308 in fewer dimensions than the HRTF data 308, the second latent space HRTF encoding 330 contains embeddings of the information represented by the user classification label 325 and the condition label(s) 326, and when the second latent space HRTF encoding 330 is sampled by the second trained decoder 334, the output can be conditioned to have the user classification and distance indicated by the ground truth condition labels 332. In some examples, the first latent space HRTF encoding 312 has a first number of dimensions and the second latent space HRTF encoding 330 has a second number of dimensions that is greater than the first number (e.g., the second latent space HRTF encoding 330 has a higher dimensionality than the first latent space HRTF encoding 312).

Referring to FIG. 4, during the inference phase, the individualized HRTF model 120 may obtain the HRTF data 144 (e.g., HRTF data that includes sets of HRTF parameters for a limited number of conditions or data that can be mapped to the HRTF parameters, such as measurement data, audio data, or image data) from a user of the device 102 or the device 220. The individualized HRTF model 120 may input the HRTF data 144 to the first trained encoder 310 to generate a first latent space HRTF encoding 400 (e.g., a latent space representation of the HRTF data 144). The first latent space HRTF encoding 400 corresponds to the first latent space HRTF encoding 312 of FIG. 3 (e.g., has the same number of dimensions) for different input data, in this example the HRTF data 144 instead of the HRTF data 308. The individualized HRTF model 120 may classify encoded HRTF data 402 (e.g., a vector representing the first latent space 400) from the first trained encoder 310 to generate the user classification 146 associated with the HRTF data 144. For example, an encoded vector (e.g., the encoded HRTF data 402) from the first latent space HRTF encoding 400 that represents the HRTF data 144 may be input to the trained classifier 306 to classify the HRTF data 144 as being associated with one or more of the candidate users associated with the HRTF database 132, as represented by the user classification 146.

The individualized HRTF model 120 may extract, based on the user classification 146, the predicted HRTF data 148 that represents a predicted set of HRTF parameters associated with the user of the device 102 or the device 220. For example, the individualized HRTF model 120 may input the user classification 146 that is output by the trained classifier 306 as a condition to the second trained decoder 334, which also may receive one or more condition labels derived from the conditions data 118 (e.g., a direction label representing a direction of a sound source, a depth label, a RIR, etc.) as additional condition(s). The second trained decoder 334 may sample the second latent space HRTF encoding 330, and based on the input and the conditions, the second trained decoder 334 may output the predicted HRTF data 148. In some examples, the HRTF data 144 may be analyzed to extract or derive the conditions data 118. The predicted HRTF data 148 can include, or be used to generate, HRTF parameters that, when applied to an audio signal by a spatial audio renderer, render individualized spatial audio to a user. In some examples, the conditions data 118 includes conditions for a set of directions, a set of distances, a set of other conditions, or a combination thereof, such that the predicted HRTF data 148 represents HRTFs for all known or expected sets of directions, distances, or other conditions. Alternatively, the conditions data 118 can include conditions associated with one or more particular sound sources for which audio is being generated instead of a set of other conditions, such that the HRTF data 148 represents HRTFs that are generated on the fly as audio from different sound sources (e.g., at different directions, distances, etc.) is generated.

Referring to FIG. 5, during the optimization phase, a user 500 may listen to playback of spatial audio that is based on the predicted HRTF data 148 via an audio device 502 (e.g., a headset, earbuds, speakers, or the like). The user 500 may provide feedback data 504 based on the output of the spatial audio that is based on the predicted HRTF data 148. The individualized HRTF model 120 (or the processor 110 or the processor 208) may perform, based on the feedback data 504, an optimization operation 506 on one or more parameters associated with the first trained encoder 310. Although referred to as an “optimization operation,” the optimization operation 506 may adjust one or more parameter values without converging to an “optimum” value, in at least some embodiments. To illustrate, the optimization operation 506 may adjust or optimize parameters in the first latent space HRTF encoding 400 based on the feedback data 504. For example, the optimization operation 506 may include or correspond to a “black box” optimization function, such as a Bayesian optimization function, that forces HRTF predictions output by the first latent space HRTF encoding 400, after decoding, to eventually converge to a sample generated based on the feedback data 504. Convergence to the sample causes the optimization operation 506 to output one or more adjusted parameters 508 to be modified at the first latent space HRTF encoding 400, which trains the first trained encoder 310 according to the one or more adjusted parameters 508. In some examples, the feedback data 504 includes HRTF data measured from other directions, distances, locations in a room, etc., that are not associated with the HRTF data 144. Additionally, or alternatively, the feedback data 504 may include user response data. For example, a UI may prompt the user 500 to indicate a direction of a sound heard by the user 500 or a rating for the sound associated with the spatial audio heard via the audio device 502, and the feedback data 504 may indicate a response provided by the user 500. The user response may include entering information through a touchscreen or keypad, looking in the direction of a sound or gesturing for a rating as captured by a camera (e.g., the camera 104 or the camera 204), speaking a response as captured by a microphone (e.g., the microphone 106 or the microphone 222), orientation or position sensor data from sensors of the audio device 502 that track head movement of the user 500, or other types of user feedback. Performing the optimization operation 506 on the first latent space HRTF encoding 400 may converge faster than performing the optimization operation 506 on the second latent space HRTF encoding 330 due to the first latent space HRTF encoding 400 being a lower-dimensional encoding than the second latent space HRTF encoding 330. Accordingly, performing the optimization operation 506 as described with reference to FIG. 5 to train the first trained encoder 310 may be quicker and less intensive to the user 500, which may improve a user experience, and may use less battery power than other types of optimization operations, thereby prolonging the operation of the audio device 502.

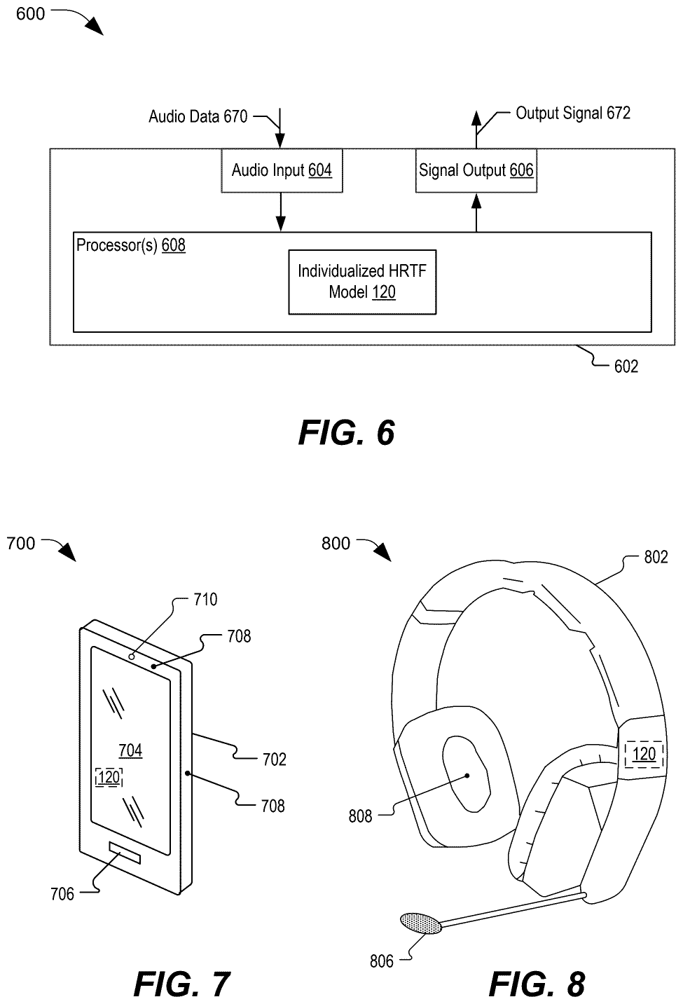

FIG. 6 is a diagram of an example of a system 600 that includes an integrated circuit 602 operable to predict individualized HRTF data, in accordance with some examples of the present disclosure. The integrated circuit 602 may include or correspond to the device 102, the device 202, or the device 220. In FIG. 6, the integrated circuit 602 includes the one or more processors 608 that include the individualized HRTF model 120. The individualized HRTF model 120 may include the decoder network 124, the encoder network 122, or both, as described above with reference to FIGS. 1-2. The processor(s) 608 may include or correspond to the processor 110, the processor 208, the processor 226, or a combination thereof.

The integrated circuit 602 also includes an audio input 604, such as one or more microphone inputs and/or bus interfaces, to enable audio data 670 to be received for processing. The audio data 670 can include or correspond to the input audio data 142 or the audio data 149, as illustrative, non-limiting examples. The integrated circuit 602 also includes a signal output 606, such as a bus interface, to enable sending of an output signal 672. For example, the output signal 672 can be sent to a speaker, such as the speaker 112 or the speaker 228. The integrated circuit 602 enables prediction of individualized HRTF data (e.g., using one or more generative ML models) and can be included as a component in a system, such as a wearable device that includes microphones, such as the headset as depicted in FIG. 8, a virtual reality, mixed reality, or augmented reality headset as depicted in FIG. 9, augmented reality headset glasses as depicted in FIG. 10, a hearing aid device as depicted in FIG. 11, earbuds as depicted in FIG. 12, or another wearable device. The integrated circuit 602 may also be a component in a system, such as a mobile phone or tablet computer device as depicted in FIG. 7, a voice-controlled speaker device as depicted in FIG. 13, a wearable electronic device as depicted in FIG. 14, a vehicle as depicted in FIG. 15, or another system.

FIG. 7 is a diagram of an illustrative aspect of a system 700 that includes a mobile device 702 operable to predict individualized HRTF data, in accordance with some examples of the present disclosure. The mobile device 702 may include or correspond to the device 102, the device 202, or the device 220, such as a phone or tablet, as illustrative, non-limiting examples. The mobile device 702 includes one or more microphones 706, one or more speakers 708, one or more cameras 710, and a display screen 704. The microphone(s) 706 may include or correspond to the microphone 106 or the microphone 222, the speaker(s) 708 may include or correspond to the speakers 112 or the speakers 228, and the camera(s) 710 may include or correspond to the camera 104 or the camera 204. One or more processors and components thereof, including the individualized HRTF model 120, are integrated in the mobile device 702 and are illustrated using dashed lines to indicate internal components that are not generally visible to a user of the mobile device 702. The individualized HRTF model 120 may include the decoder network 124, the encoder network 122, or both, as described above with reference to FIGS. 1-2.

In a particular example of operation, the mobile device 702 is configured to support generation of spatialized audio data at another device. For example, the individualized HRTF model 120 may be operable to obtain input data, such as from a camera or a user interface, that represents HRTF data associated with a user of the mobile device 702, input the HRTF data to a trained encoder (e.g., within the encoder network 122) to generate encoded HRTF data, classify the encoded HRTF data to generate a user classification associated with the HRTF data, and output (e.g., to the decoder network 124 or the other device) the user classification that associates the user with at least one candidate user of a plurality of candidate users. Generating the user classification enables the mobile device 702 to support prediction of the predicted HRTF data for use in generating spatialized audio data that is individualized to the user and can be adapted based on user feedback. In other examples, the mobile device 702 may generate spatialized audio data using predicted HRTF data extracted from the user classification in order to transit the spatialized audio data (e.g., a binauralized signal) to earpiece device(s) or a headset worn by the user.

FIG. 8 is a diagram of an illustrative aspect of a system 800 that includes a headset device 802 operable to predict individualized HRTF data, in accordance with some examples of the present disclosure. The headset device 802 may include or correspond to the device 102, the device 202, or the device 220. The headset device 802 includes one or more microphones 806 and one or more speakers 808. The microphone(s) 806 may include or correspond to the microphone 106 or the microphone 222, and the speaker(s) 808 may include or correspond to the speakers 112 or the speakers 228. One or more processors and components thereof, including the individualized HRTF model 120, are integrated in the headset device 802 and depicted using dashed lines to indicate components not generally visible to a user of the headset device 802. The individualized HRTF model 120 may include the decoder network 124, the encoder network 122, or both, as described above with reference to FIGS. 1-2.

In a particular example of operation, the individualized HRTF model 120 is operable to obtain a user classification, extract predicted HRTF data that represents parameters of a predicted HRTF from a latent space HRTF encoding, and output, via the speaker(s) 808, spatial audio data based on audio data and the predicted HRTF data. The user classification may be received from another device or generated by the individualized HRTF model 120 (e.g., the encoder network 122). For example, the individualized HRTF model 120 may be operable to obtain input data (e.g., data indicative of HRTF data associated with a user of the headset device 802), input the HRTF data to a trained encoder (e.g., within the encoder network 122) to generate encoded HRTF data, classify the encoded HRTF data to generate the user classification associated with the HRTF data, and output (e.g., to the decoder network 124) the user classification that associates the user with at least one candidate user of a plurality of candidate users. Generating the spatial audio data enables the headset device 802 to predict HRTF data and use the predicted HRTF data to generate spatialized audio data that is individualized to the user and can be adapted based on user feedback.

FIG. 9 is a diagram of an illustrative aspect of a system that includes a portable electronic device, such as a headset 902, operable to predict individualized HRTF data, in accordance with some examples of the present disclosure. The headset 902 can include or correspond to a virtual reality, mixed reality, or augmented reality headset device. The headset 902 may include or correspond to the device 102, the device 202, or the device 220. A visual interface device is positioned in front of the user's eyes to enable display of augmented reality, mixed reality, or virtual reality images or scenes to the user while the headset 902 is worn. The headset 902 also includes one or more microphones 906 and one or more speakers 908. The microphone(s) 906 may include or correspond to the microphone 106 or microphone 222, and the speaker(s) 908 may include or correspond to the speakers 112 or the speakers 228. One or more processors and components thereof, including the individualized HRTF model 120, are integrated in the headset 902 and depicted using dashed lines to indicate components not generally visible to a user of the headset 902. The individualized HRTF model 120 may include the decoder network 124, the encoder network 122, or both, as described above with reference to FIGS. 1-2.

In a particular example of operation, the headset 902 is configured to output spatialized audio data via the speaker(s) 908 that corresponds to visual data displayed via the visual interface device. In such an example, the individualized HRTF model 120 is operable to obtain a user classification, extract predicted HRTF data that represents parameters of a predicted HRTF from a latent space HRTF encoding, and output, via the speaker(s) 908, spatial audio data based on audio data and the predicted HRTF data. The user classification may be received from another device or generated by the individualized HRTF model 120 (e.g., the encoder network 122). For example, the individualized HRTF model 120 may be operable to obtain input data (e.g., data indicative of HRTF data associated with a user of the headset 902), input the HRTF data to a trained encoder (e.g., within the encoder network 122) to generate encoded HRTF data, classify the encoded HRTF data to generate the user classification associated with the HRTF data, and output (e.g., to the decoder network 124) the user classification that associates the user with at least one candidate user of a plurality of candidate users. Generating the spatial audio data enables the headset 902 to predict HRTF data and use the predicted HRTF data to generate spatialized audio data that is individualized to the user and can be adapted based on user feedback.

FIG. 10 is a diagram of an illustrative aspect of a system 1000 that includes augmented reality glasses 1002 operable to predict individualized HRTF data, in accordance with some examples of the present disclosure. The augmented reality glasses 1002 may include or correspond to the device 102, the device 202, or the device 220. The glasses 1002 include a holographic projection unit 1004 configured to project visual data onto a surface of a lens 1006 or to reflect the visual data off of a surface of the lens 1006 and onto the wearer's retina. The glasses 1002 also include one or more speakers 1008 and one or more cameras 1010. The speaker(s) 1008 may include or correspond to the speakers 112 or the speakers 228, and the camera(s) 1010 may include or correspond to the camera 104 or the camera 204. One or more processors and components thereof, including the individualized HRTF model 120, are integrated in the glasses 1002 and depicted using dashed lines to indicate components not generally visible to a user of the glasses 1002. The individualized HRTF model 120 may include the decoder network 124, the encoder network 122, or both, as described above with reference to FIGS. 1-2.

In a particular example of operation, the glasses 1002 are configured to output spatialized audio data via the speaker(s) 1008 that corresponds to visual data projected by the holographic projection unit 1004. In such an example, the individualized HRTF model 120 is operable to obtain a user classification, extract predicted HRTF data that represents parameters of a predicted HRTF from a latent space HRTF encoding, and output, via the speaker(s) 1008, spatial audio data based on audio data and the predicted HRTF data. The user classification may be received from another device or generated by the individualized HRTF model 120 (e.g., the encoder network 122). For example, the individualized HRTF model 120 may be operable to obtain input data (e.g., data indicative of HRTF data associated with a user of the glasses 1002), input the HRTF data to a trained encoder (e.g., within the encoder network 122) to generate encoded HRTF data, classify the encoded HRTF data to generate the user classification associated with the HRTF data, and output (e.g., to the decoder network 124) the user classification that associates the user with at least one candidate user of a plurality of candidate users. Generating the spatial audio data enables the glasses 1002 to predict HRTF data and use the predicted HRTF data to generate spatialized audio data that is individualized to the user and can be adapted based on user feedback.

FIG. 11 is a diagram of an illustrative aspect of a system 1100 that includes a wearable device operable to predict individualized HRTF data, in accordance with some examples of the present disclosure. The wearable device, such as a hearing aid device 1102, may include or correspond to the device 102, the device 202, or the device 220. In the example illustrated in FIG. 11, the hearing aid device 1102 includes a portion 1104 configured to be worn behind an car of the user, a portion 1108 configured to extend over the car, and a portion 1106 to be worn at or near an car canal of the user. In other examples, the hearing aid device 1102 has a different configuration or form factor. To illustrate, the hearing aid device 1102 can be an in-ear device that does not include the portion 1104 configured to be worn behind an ear and the portion 1108 configured to extend over the ear. In the example illustrated in FIG. 11, the hearing aid device 1102 includes one or more microphones 1110 and one or more speakers 1112. The microphone(s) 1110 may include or correspond to the microphone 106 or the microphone 222, and the speaker(s) 1112 may include or correspond to the speakers 112 or the speakers 228. One or more processors and components thereof, including the individualized HRTF model 120, are integrated in the hearing aid device 1102 and depicted using dashed lines to indicate components not generally visible to a user of the hearing aid device 1102. The individualized HRTF model 120 may include the decoder network 124, the encoder network 122, or both, as described above with reference to FIGS. 1-2.

In a particular example of operation, the hearing aid device 1102 is configured to output spatialized audio data via the speaker(s) 1112. In such an example, the individualized HRTF model 120 is operable to obtain a user classification, extract predicted HRTF data that represents parameters of a predicted HRTF from a latent space HRTF encoding, and output, via the speaker(s) 1112, spatial audio data based on audio data and the predicted HRTF data. The user classification may be received from another device or generated by the individualized HRTF model 120 (e.g., the encoder network 122). For example, the individualized HRTF model 120 may be operable to obtain input data (e.g., data indicative of HRTF data associated with a user of the hearing aid device 1102), input the HRTF data to a trained encoder (e.g., within the encoder network 122) to generate encoded HRTF data, classify the encoded HRTF data to generate the user classification associated with the HRTF data, and output (e.g., to the decoder network 124) the user classification that associates the user with at least one candidate user of a plurality of candidate users. Generating the spatial audio data enables the hearing aid device 1102 to predict the HRTF data and use the predicted HRTF data to generate spatialized audio data that is individualized to the user and can be adapted based on user feedback.

FIG. 12 is a diagram of an illustrative aspect of a system 1200 that includes earbuds 1206 operable to predict individualized HRTF data, in accordance with some examples of the present disclosure. The earbuds 1206 may include or correspond to the device 102, the device 202, or the device 220. The earbuds 1206 may include a single earbud or multiple earbuds, such as a first earbud 1202 and a second earbud 1204. Although a particular type/style of the earbuds 1206 are described and shown, it should be understood that the present technology can be applied to other in-ear or over-ear audio devices.

In the example illustrated in FIG. 12, the first earbud 1202 includes a first microphone 1210A, such as a high signal-to-noise microphone positioned to capture the voice of a wearer of the first earbud 1202, one or more other microphones configured to detect ambient sounds and spatially distributed to support beamforming, illustrated as microphone(s) 1212A, an “inner” microphone 1214A proximate to the wearer's ear canal (e.g., to assist with active noise cancelling), and a self-speech microphone 1216A, such as a bone conduction microphone configured to convert sound vibrations of the wearer's ear bone or skull into an audio signal. In a particular implementation, the microphone(s) 1210 A, 1212A, 1214A, or 1216A correspond to the microphone 106 or the microphone 222. The first earbud 1202 also includes a speaker 1220A, which can include or correspond to the speakers 112 or the speakers of 228. The first earbud 1202, the second earbud 1204, or both, also include one or more processors and components thereof, including the individualized HRTF model 120, integrated in the first earbud 1202 and illustrated using dashed lines to indicate internal components that are not generally visible to a user of the first earbud 1202. The individualized HRTF model 120 integrated in the first earbud 1202 may include the decoder network 124, the encoder network 122, or both, as described above with reference to FIGS. 1-2.

The second earbud 1204 can be configured in a substantially similar manner as the first earbud 1202. For example, the second earbud can include a microphone 1210B positioned to capture the voice of a wearer of the second earbud 1204, one or more other microphones 1212B configured to detect ambient sounds and spatially distributed to support beamforming, an “inner” microphone 1214B, and a self-speech microphone 1216B. The second earbud 1204 also includes a speaker 1220B, which can include or correspond to the speakers 112 or the speakers 228.

In some examples, the earbuds 1202, 1204 are configured to automatically switch between various operating modes, such as a passthrough mode in which ambient sound is processed for output via the speaker(s) 1220, and a playback mode in which non-ambient sound (e.g., streaming audio corresponding to a phone conversation, media playback, video game, etc.) is played back through the speaker(s) 1220. In other examples, the earbuds 1202, 1204 may support fewer modes or may support one or more other modes in place of, or in addition to, the described modes.

In an illustrative example, the earbuds 1202, 1204 can automatically transition from the playback mode to the passthrough mode in response to detecting the wearer's voice and may automatically transition back to the playback mode after the wearer has ceased speaking. In some examples, the earbuds 1202, 1204 can operate in two or more of the modes concurrently, such as by performing audio zoom on a particular ambient sound (e.g., a dog barking) and playing out the audio zoomed sound superimposed on the sound being played out while the wearer is listening to music (which can be reduced in volume while the audio zoomed sound is being played). In this example, the wearer can be alerted to the ambient sound associated with the audio event without halting playback of the music.

In a particular example of operation, the earbuds 1202, 1204 are configured to output spatialized audio data via the speaker(s) 1220. In such an example, the individualized HRTF models 120 are operable to obtain a user classification, extract predicted HRTF data that represents parameters of a predicted HRTF from a latent space HRTF encoding, and output, via the speaker(s) 1220, spatial audio data based on audio data and the predicted HRTF data. The user classification may be received from another device or generated by the individualized HRTF model 120 (e.g., the encoder network 122). For example, the individualized HRTF models 120 may be operable to obtain input data (e.g., data indicative of HRTF data associated with a user of the hearing aid device 1102), input the HRTF data to a trained encoder (e.g., within the encoder network 122) to generate encoded HRTF data, classify the encoded HRTF data to generate the user classification associated with the HRTF data, and output (e.g., to the decoder network 124) the user classification that associates the user with at least one candidate user of a plurality of candidate users. Generating the spatial audio data enables the earbuds 1202, 1204 to predict HRTF data and to use the predicted HRTF data to generate spatialized audio data that is individualized to the user and can be adapted based on user feedback.

FIG. 13 is a diagram of an illustrative aspect of a system 1300 that includes a voice-controlled speaker device 1302 operable to predict individualized HRTF data, in accordance with some examples of the present disclosure. The voice-controlled speaker device 1302 may include or correspond to the device 102, the device 202, or the device 220. The voice-controlled speaker device 1302 can have wireless network connectivity and is configured to execute an assistant operation. The voice-controlled speaker device 1302 includes one or more microphones 1306 and one or more speakers 1308. The microphone(s) 1306 may include or correspond to the microphone 106 or the microphone 222, and the speaker(s) 1308 may include or correspond to the speakers 112 or the speakers 228. One or more processors and components thereof, including the individualized HRTF model 120, are integrated in the voice-controlled speaker device 1302 and depicted using dashed lines to indicate components not generally visible to a user of the voice-controlled speaker device 1302. The individualized HRTF model 120 may include the decoder network 124, the encoder network 122, or both, as described above with reference to FIGS. 1-2.

In a particular example of operation, the voice-controlled speaker device 1302 is configured to output spatialized audio data via the speaker(s) 1308. In such an example, the individualized HRTF model 120 is operable to obtain a user classification, extract predicted HRTF data that represents parameters of a predicted HRTF from a latent space HRTF encoding, and output, via the speaker(s) 1308, spatial audio data based on audio data and the predicted HRTF data. The user classification may be received from another device or generated by the individualized HRTF model 120 (e.g., the encoder network 122). For example, the individualized HRTF model 120 may be operable to obtain input data (e.g., data indicative of HRTF data associated with a user of the voice-controlled speaker device 1302), input the HRTF data to a trained encoder (e.g., within the encoder network 122) to generate encoded HRTF data, classify the encoded HRTF data to generate the user classification associated with the HRTF data, and output (e.g., to the decoder network 124) the user classification that associates the user with at least one candidate user of a plurality of candidate users. Generating the spatial audio data enables the voice-controlled speaker device 1302 to predict HRTF data and use the predicted HRTF data to generate spatialized audio data that is individualized to the user and can be adapted based on user feedback. Alternatively, instead of playout out the spatialized audio data via the speaker(s) 1308, the voice-controlled speaker device 1302 may transit the spatialized audio data (e.g., a binauralized signal) to earpiece device(s) or a headset worn by the user.

FIG. 14 is a diagram of an illustrative aspect of a system 1400 that includes a wearable electronic device 1402 operable to predict individualized HRTF data, in accordance with some examples of the present disclosure. The wearable electronic device 1402, illustrated as a “smart watch” in FIG. 14, may include or correspond to the device 102, the device 202, or the device 220. In the example shown in FIG. 14, the wearable electronic device 1402 includes a display screen 1404, one or more microphones 1406, and one or more speakers 1408. The microphone(s) 1406 may include or correspond to the microphone 106 or the microphone 222, and the speaker(s) 1408 may include or correspond to the speakers 112 or the speakers 228. One or more processors and components thereof, including the individualized HRTF model 120, are integrated in the wearable electronic device 1402 and depicted using dashed lines to indicate components not generally visible to a user of the wearable electronic device 1402. The individualized HRTF model 120 may include the decoder network 124, the encoder network 122, or both, as described above with reference to FIGS. 1-2.

In a particular example of operation, the wearable electronic device 1402 is configured to support generation of spatialized audio data at another device. For example, the individualized HRTF model 120 may be operable to obtain input data, such as from a camera or a user interface, that represents HRTF data associated with a user of the wearable electronic device 1402, input the HRTF data to a trained encoder (e.g., within the encoder network 122) to generate encoded HRTF data, classify the encoded HRTF data to generate a user classification associated with the HRTF data, and output (e.g., to the decoder network 124 or the other device) the user classification that associates the user with at least one candidate user of a plurality of candidate users. Generating the user classification enables the wearable electronic device 1402 to predict HRTF data and use the predicted HRTF data for use in generating spatialized audio data that is individualized to the user and can be adapted based on user feedback. In other examples, the wearable electronic device 1402 may generate spatialized audio data using predicted HRTF data extracted from the user classification in order to transit the spatialized audio data (e.g., a binauralized signal) to earpiece device(s) or a headset worn by the user.

FIG. 15 is a diagram of an illustrative aspect of a system 1500 that includes a vehicle 1502 operable to predict individualized HRTF data, in accordance with some examples of the present disclosure. FIG. 15 depicts the system 1500 in which a device (e.g., the device 102, the device 202, or the device 220) corresponds to, or is integrated within, the vehicle 1502, illustrated as a car, such as an electric car. Although the vehicle 1502 is depicted as a car, in other examples, the vehicle 1502 may be another type of vehicle, such as an aerial vehicle (e.g., an airplane). The vehicle 1502 includes a display screen 1520, one or more microphones 1506, and one or more speakers 1508. The microphone(s) 1506 may include or correspond to the microphone 106 or the microphone 222, and the speaker(s) 1508 may include or correspond to the speakers 112 or the speakers 228. One or more processors and components thereof, including the individualized HRTF model 120, are integrated in the vehicle 1502 and depicted using dashed lines to indicate components not generally visible to a user of the vehicle 1502. The individualized HRTF model 120 may include the decoder network 124, the encoder network 122, or both, as described above with reference to FIGS. 1-2.

In a particular example of operation, the vehicle 1502 is configured to output spatialized audio data via the speaker(s) 1508. In such an example, the individualized HRTF model 120 is operable to obtain a user classification, extract predicted HRTF data that represents parameters of a predicted HRTF from a latent space HRTF encoding, and output, via the speaker(s) 1508, spatial audio data based on audio data and the predicted HRTF data. The user classification may be received from another device or generated by the individualized HRTF model 120 (e.g., the encoder network 122). For example, the individualized HRTF model 120 may be operable to obtain input data (e.g., data indicative of HRTF data associated with a user of the hearing aid device 1102), input the HRTF data to a trained encoder (e.g., within the encoder network 122) to generate encoded HRTF data, classify the encoded HRTF data to generate the user classification associated with the HRTF data, and output (e.g., to the decoder network 124) the user classification that associates the user with at least one candidate user of a plurality of candidate users. Generating the spatial audio data enables the vehicle 1502 to predict HRTF data and use the predicted HRTF data to generate spatialized audio data that is individualized to the user and can be adapted based on user feedback. Alternatively, instead of playout out the spatialized audio data via the speaker(s) 1508, the vehicle 1502 may transit the spatialized audio data (e.g., a binauralized signal) to earpiece device(s) or a headset worn by the user.

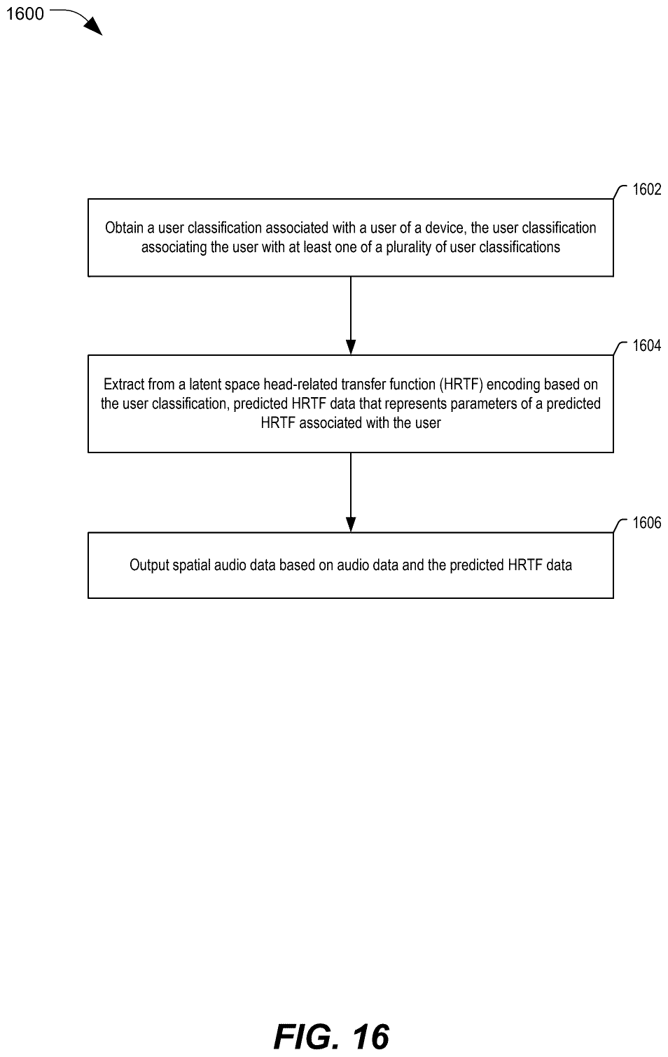

FIG. 16 is a diagram of a particular implementation of a method 1600 of predicting individualized HRTF data, in accordance with some examples of the present disclosure. The method 1600 may be performed by the device 102 (e.g., an audio device) of FIG. 1, the device 220 of FIG. 2, the individualized HRTF model 120 of FIGS. 3-5, the integrated circuit 602 of FIG. 6, the mobile device 702 of FIG. 7, the headset device 802 of FIG. 8, the headset 902 of FIG. 9, the glasses 1002 of FIG. 10, the hearing aid device 1102 of FIG. 11, the earbuds 1202, 1204 of FIG. 12, the voice-controlled speaker device 1302 of FIG. 13, the wearable electronic device 1402 of FIG. 14, the vehicle 1502 of FIG. 15, or a combination thereof.

The method 1600 includes, at block 1602, obtaining a user classification associated with a user of a device. The user classification associates the user with at least one of a plurality of user classifications. For example, the user classification may include or correspond to the user classification 146 that is output by the encoder network 122 of FIG. 1 or received via wireless transmission from the device 202 of FIG. 2.

At block 1604, the method 1600 includes extracting, from a latent space HRTF encoding based on the user classification, predicted HRTF data that represents parameters of a predicted HRTF associated with the user. For example, the predicted HRTF data may include or correspond to the predicted HRTF data 148 that is output by the decoder network 124 at the device 102 of FIG. 1 or the device 220 of FIG. 2. The decoder network 124 includes the second trained decoder 334 of FIG. 4 that extracts the predicted HRTF data 148 from the second latent space HRTF encoding 330.

At block 1606, the method 1600 includes outputting, by the one or more processors, spatial audio data based on audio data and the predicted HRTF data. For example, the spatial audio renderer 126 of FIG. 1 or FIG. 2 may output the spatial audio data 150 based on the predicted HRTF data 148 and the audio data 149.

In some examples, extracting the predicted HRTF data includes inputting the user classification to a trained decoder to generate the predicted HRTF data. For example, the decoder network 124 includes the second trained decoder 334 that generates the predicted HRTF data 148 based on the user classification 146, as further described above with reference to FIG. 4. In some such examples, the trained decoder is included in a conditional variational autoencoder and is trained to generate the predicted HRTF data based on at least the user classification and the latent space HRTF encoding. For example, the second trained decoder 334 may be a cVAE that is configured to generate the predicted HRTF data 148 based on the user classification 146, the second latent space HRTF encoding 330, and the conditions data 118.

One technical advantage of the method 1600 as described above is that the method 1600 may output predicted HRTF data, which can be used to enable output of spatial audio, that is more individualized to a user of a device than typical spatial audio systems that merely match the user to one of a small set of existing HRTFs. To illustrate, the method 1600 extracts the predicted HRTF data from a user classification (e.g., a classification that associates a user with one or more predefined candidate users having pre-measured HRTF functions), resulting in finer tuned, more individualized HRTF parameters for one or more conditions than the pre-measured HRTF functions. As such, the user experience of the user when listening to the spatial audio is improved as compared to generating spatial audio based on one of the pre-measured HRTFs.

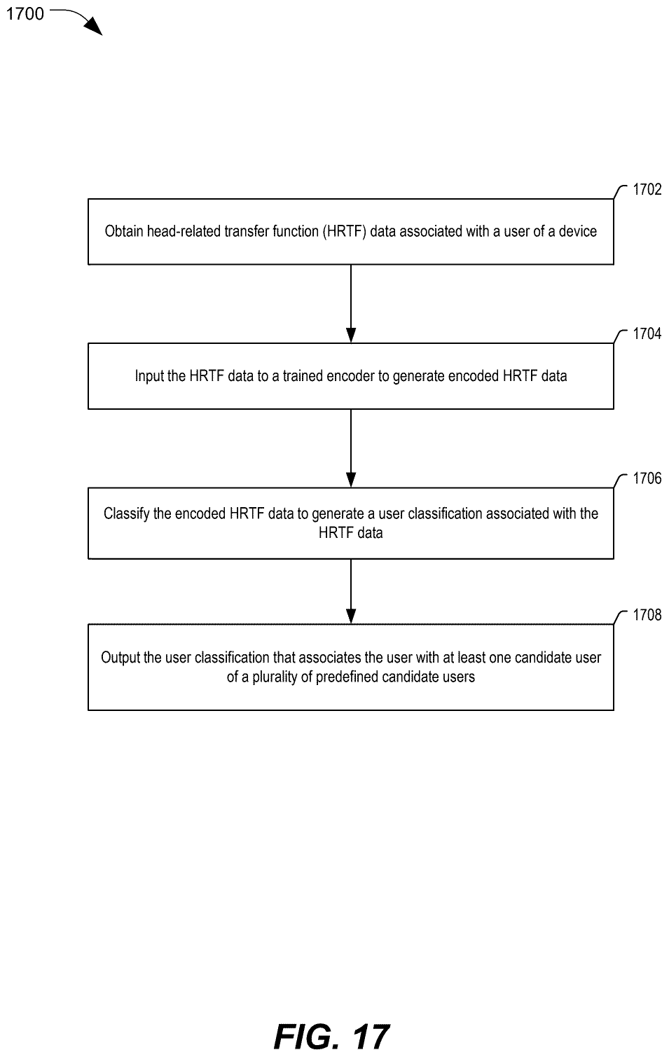

FIG. 17 is a diagram of a particular implementation of a method 1700 of ML-based encoding of input data for user classification, in accordance with some examples of the present disclosure. The method 1700 may be performed by the device 102 (e.g., an audio device) of FIG. 1, the device 202 of FIG. 2, the individualized HRTF model 120 of FIGS. 3-5, the integrated circuit 602 of FIG. 6, the mobile device 702 of FIG. 7, the headset device 802 of FIG. 8, the headset 902 of FIG. 9, the glasses 1002 of FIG. 10, the hearing aid device 1102 of FIG. 11, the earbuds 1202, 1204 of FIG. 12, the voice-controlled speaker device 1302 of FIG. 13, the wearable electronic device 1402 of FIG. 14, the vehicle 1502 of FIG. 15, or a combination thereof.

The method 1700 includes, at block 1702, obtaining HRTF data associated with a user of a device. For example, the HRTF data may include or correspond to the HRTF data 144 of FIGS. 1-2. In some examples, the HRTF data 144 includes or is based on the image data 140 from the camera 104 (or the camera 204), the input audio data 142 from the microphone 106 (or the microphone 222), data input by a user, data received from another device, or a combination thereof.

At block 1704, the method 1700 includes inputting the HRTF data to a trained encoder to generate encoded HRTF data. For example, the HRTF data 144 may be input to the encoder network 122 to generate encoded HRTF data. In aspects, the encoder network 122 includes the first trained encoder 310 that is configured to generate the encoded HRTF data 402 of FIG. 4 based on the HRTF data 144.

At block 1706, the method 1700 includes classifying the encoded HRTF data to generate a user classification associated with the HRTF data. For example, the user classification may include or correspond to the user classification 146 that is output by the encoder network 122 of FIG. 1 or FIG. 2. At block 1708, the method 1700 includes outputting the user classification that associates the user with at least one candidate user of a plurality of predefined candidate users. For example, the user classification 146 may be output from the encoder network 122 to the decoder network 124, as described with reference to FIG. 1, or the user classification 146 may be transmitted from the device 202 to the device 220, as described with reference to FIG. 2.

In some examples, classifying the encoded HRTF data includes inputting the encoded HRTF data to a trained classifier to generate the user classification. For example, the encoder network 122 may include the trained classifier 306 that generates the user classification 146 based on the encoded HRTF data 402. In some such examples, the trained encoder is included in a variational autoencoder and is trained to generate the encoded HRTF data based on a first latent space HRTF encoding. For example, the first trained encoder 310 may be included in the VAE 304 and be trained to generate the encoded HRTF data 402 based on the first latent space HRTF encoding 400. In some such examples, the trained classifier includes a DNN that is trained to classify the encoded HRTF data as one or more of a plurality of user classifications. For example, the trained classifier 306 may be a DNN or another type of classifier that generates classification outputs that associate a user of corresponding input HRTF data (e.g., the HRTF data 144) with one or more candidate users in the HRTF database 132.

One technical advantage of the method 1700 as described above is that the method 1700 may generate a user classification that associates a user with one or more predefined candidate users quickly and consistently for different users. To illustrate, the method 1700 generates the user classification based on encoded HRTF data that is encoded according to a lower-dimensional latent space HRTF encoding than is used to generate predicted HRTF data. By using two latent space HRTF encodings (e.g., an encoder network and a decoder network), the encoding performed in the method 1700 converges faster to a consistent user classification for the same input HRTF data. Additionally, in some examples, parameters of the lower-dimensional latent space encoding can be adjusted (e.g., optimized) based on feedback data to further improve the consistency and accuracy of the classification in a manner that converges faster, and therefore uses less power, as compared to the time and effort-intensive optimization processes performed by other HRTF measurement systems.

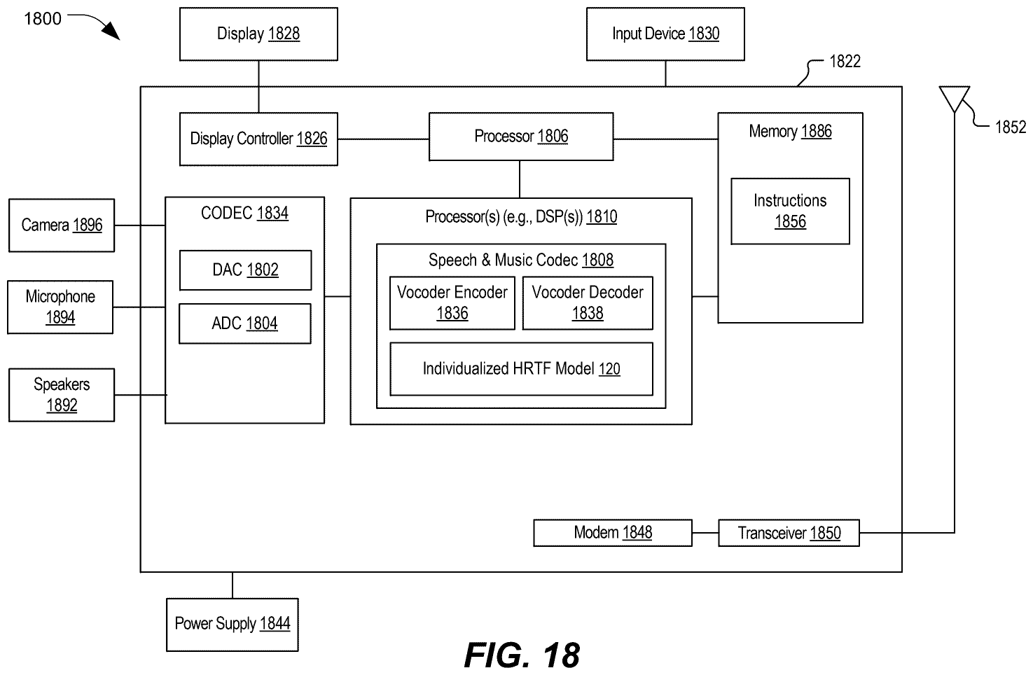

The method 1600 of FIG. 16, the method 1700 of FIG. 17, or a combination thereof, may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 1600 of FIG. 16, the method 1700 of FIG. 17, or a combination thereof, may be performed by a processor that executes instructions, such as described with reference to FIG. 18.

Referring to FIG. 18, a block diagram of a particular illustrative implementation of a device 1800 is depicted. The device 1800 is operable to predict individualized HRTF data, in accordance with some examples of the present disclosure. In various examples, the device 1800 may have more or fewer components than illustrated in FIG. 18. In an illustrative implementation, the device 1800 may correspond to the device 102, the device 202, or the device 220. In an illustrative implementation, the device 1800 may perform one or more operations described with reference to FIGS. 1-17.

In a particular implementation, the device 1800 includes a processor 1806 (e.g., a central processing unit (CPU)). The device 1800 may include one or more additional processors 1810 (e.g., one or more DSPs). In a particular aspect, the processor 110 of FIG. 1, the processor 208, or the processor 226 of FIG. 2 corresponds to the processor 1806, the processors 1810, or a combination thereof. The processors 1810 may include a speech and music coder-decoder (CODEC) 1808 that includes a voice coder (“vocoder”) encoder 1836, a vocoder decoder 1838, the individualized HRTF model 120, or a combination thereof. The individualized HRTF model 120 may include the decoder network 124, the encoder network 122, or both, as described above with reference to FIGS. 1-2.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, central processing units (CPUs), digital signal processors (DSPs), neural processing units (NPU), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a GPU are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnect sets of transistors and memory elements) that can be configured (often on the fly) to perform customizable logic functions.

The device 1800 may include a memory 1886 and a CODEC 1834. The memory 1886 may include instructions 1856, that are executable by the one or more additional processors 1810 (or the processor 1806) to implement the functionality described with reference to the individualized HRTF model 120. The device 1800 may include the modem 1848 coupled, via a transceiver 1850, to an antenna 1852.

The device 1800 may include a display 1828 coupled to a display controller 1826. One or more speakers 1892, one or more microphones 1894, and a camera 1896 may be coupled to the CODEC 1834. The CODEC 1834 may include a digital-to-analog converter (DAC) 1802, an analog-to-digital converter (ADC) 1804, or both. In a particular implementation, the CODEC 1834 may receive analog signals from the microphone(s) 1894, convert the analog signals to digital signals using the ADC 1804, and provide the digital signals to the speech and music codec 1808. The speech and music codec 1808 may process the digital signals, and the digital signals may further be processed by the individualized HRTF model 120. In a particular implementation, the speech and music codec 1808 may provide digital signals to the CODEC 1834. The CODEC 1834 may convert the digital signals to analog signals using the digital-to-analog converter 1802 and may provide the analog signals to the speaker 1892. In a particular implementation, the CODEC 1834 may receive analog signals from the camera 1896, convert the analog signals to digital signals using the ADC 1804, and provide the digital signals to the processors 1810 (or the processor 1806).

In a particular implementation, the device 1800 may be included in a system-in-package or system-on-chip device 1822. In a particular implementation, the memory 1886, the processor 1806, the processors 1810, the display controller 1826, the CODEC 1834, and the modem 1848 are included in the system-in-package or system-on-chip device 1822. In a particular implementation, an input device 1830 and a power supply 1844 are coupled to the system-in-package or the system-on-chip device 1822. Moreover, in a particular implementation, as illustrated in FIG. 18, the display 1828, the input device 1830, the speaker(s) 1892, the microphone(s) 1894, the camera 1896, the antenna 1852, and the power supply 1844 are external to the system-in-package or the system-on-chip device 1822. In a particular implementation, each of the display 1828, the input device 1830, the speaker(s) 1892, the microphone(s) 1894, the antenna 1852, and the power supply 1844 may be coupled to a component of the system-in-package or the system-on-chip device 1822, such as an interface or a controller.

The device 1800 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described embodiments, an apparatus includes means for obtaining a user classification associated with a user of a device. The user classification associates the user with at least one of a plurality of user classifications. For example, the means for obtaining can include the individualized HRTF model 120, the encoder network 122, the processor 110, the modem 114, the modem 225, the trained classifier 306, the integrated circuit 602, the processor 1806, the processor(s) 1810, the system-in-package or the system-on-chip device 1822, the modem 1848, the device 1800, other circuitry configured to obtain a user classification associated with a user of a device, or a combination thereof.

The apparatus also includes means for means for extracting, from a latent space HRTF encoding based on the user classification, predicted HRTF data that represents parameters of a predicted HRTF associated with the user. For example, the means for extracting can include the individualized HRTF model 120, the decoder network 124, the processor 110, the processor 226, the second trained decoder 334, the integrated circuit 602, the processor 1806, the processor(s) 1810, the system-in-package or the system-on-chip device 1822, the device 1800, other circuitry configured to extract predicted HRTF data from a latent space HRTF encoding based on a user classification, or a combination thereof.

The apparatus further includes means for outputting spatial audio data based on audio data and the predicted HRTF data. For example, the means for outputting can include the processor 110, the spatial audio renderer 126, the speakers 112, the processor 226, the speakers 228, the integrated circuit 602, the processor 1806, the processor(s) 1810, the system-in-package or the system-on-chip device 1822, the speakers 1892, the device 1800, other circuitry configured to output spatial audio data based on audio data and predicted HRTF data, or a combination thereof.

In conjunction with the described embodiments, an apparatus includes means for obtaining HRTF data associated with a user of a device. For example, the means for obtaining can include the camera 104, the modem 114, the processor 110, the microphone 106, the camera 204, the processor 208, the modem 210, the integrated circuit 602, the processor 1806, the processor(s) 1810, the system-in-package or the system-on-chip device 1822, the microphone 1894, the camera 1896, the device 1800, other circuitry configured to obtain HRTF data associated with a user of a device, or a combination thereof.

The apparatus also includes trained encoding means for generating encoded HRTF data based on the HRTF data. For example, the trained encoding means can include the individualized HRTF model 120, the encoder network 122, the processor 110, the processor 208, the first trained encoder 310, the integrated circuit 602, the processor 1806, the processor(s) 1810, the system-in-package or the system-on-chip device 1822, the device 1800, other circuitry configured to generate encoded HRTF data based on HRTF data and that is trained for encoding, or a combination thereof.

The apparatus includes means for classifying the encoded HRTF data to generate a user classification associated with the HRTF data. For example, the means for classifying can include the individualized HRTF model 120, the encoder network 122, the processor 110, the processor 208, the trained classifier 306, the integrated circuit 602, the processor 1806, the processor(s) 1810, the system-in-package or the system-on-chip device 1822, the device 1800, other circuitry configured to classify encoded HRTF data to generate a user classification, or a combination thereof.

The apparatus further includes means for outputting the user classification that associates the user with at least one candidate user of a plurality of predefined candidate users. For example, the means for outputting can include the processor 110, the modem 114, the processor 208, the modem 210, the integrated circuit 602, the processor 1806, the processor(s) 1810, the system-in-package or the system-on-chip device 1822, the device 1800, the modem 1848, other circuitry configured to output a user classification that associates a user with at least one candidate user of a plurality of predefined candidate users, or a combination thereof.

In some examples, a non-transitory computer-readable medium (e.g., a computer-readable storage device, such as the memory 1886) includes instructions (e.g., the instructions 1856) that, when executed by one or more processors (e.g., the one or more processors 1810 or the processor 1806), cause the one or more processors to obtain a user classification (e.g., the user classification 146) associated with a user of a device. The user classification associates the user with at least one of a plurality of user classifications. The instructions are also executable by the one or more processors to cause the one or more processors to extract, from a latent space HRTF encoding (e.g., the first latent space HRTF encoding 400) based on the user classification, predicted HRTF data (e.g., the predicted HRTF data 148) that represents parameters of a predicted HRTF associated with a user. The instructions are further executable by the one or more processors to cause the one or more processors to output spatial audio data (e.g., the spatial audio data 150) based on audio data (e.g., the audio data 149) and the predicted HRTF data.

In some examples, a non-transitory computer-readable medium (e.g., a computer-readable storage device, such as the memory 1886) includes instructions (e.g., the instructions 1856) that, when executed by one or more processors (e.g., the one or more processors 1810 or the processor 1806), cause the one or more processors to obtain HRTF data (e.g., the HRTF data 144) associated with a user of a device. The instructions are also executable by the one or more processors to cause the one or more processors to input the HRTF data to a trained encoder (e.g., the first trained encoder 310) to generate encoded HRTF data (e.g., the encoded HRTF data 402). The instructions are executable by the one or more processors to cause the one or more processors to classify the encoded HRTF data to generate a user classification (e.g., the user classification 146) associated with the HRTF data. The instructions are further executable by the one or more processors to cause the one or more processors to output the user classification that associates the user with at least one candidate user of a plurality of predefined candidate users.

Particular aspects of the disclosure are described below in sets of interrelated Examples:

According to Example 1, a device includes a memory configured to store a user classification associated with a user of the device, the user classification associating the user with at least one of a plurality of user classifications. The device also includes one or more processors coupled to the memory, wherein the one or more processors are configured to: obtain the user classification; extract, from a latent space head-related transfer function (HRTF) encoding based on the user classification, predicted HRTF data that represents parameters of a predicted HRTF associated with the user; and output spatial audio data based on audio data and the predicted HRTF data.

Example 2 includes the device of Example 1, wherein the one or more processors are further configured to input the user classification to a trained decoder to generate the predicted HRTF data.

Example 3 includes the device of Example 2, wherein the trained decoder is included in a conditional variational autoencoder and is trained to generate the predicted HRTF data based on at least the user classification and the latent space HRTF encoding.

Example 4 includes the device of any of Examples 1 to 3, wherein the one or more processors are configured to extract the predicted HRTF data based further on direction data that indicates a direction of a sound source that corresponds to the spatial audio data.

Example 5 includes the device of any of Examples 1 to 4, wherein the one or more processors are configured to extract the predicted HRTF data based further on distance data that indicates a distance between the device and a sound source that corresponds to the spatial audio data.

Example 6 includes the device of any of Examples 1 to 5, wherein the one or more processors are configured to extract the predicted HRTF data based further on room data that corresponds to a room impulse response function (RIR) of a room in which the device is located.

Example 7 includes the device of any of Examples 1 to 6, wherein the one or more processors are further configured to: input HRTF data to a trained encoder to generate encoded HRTF data; input the encoded HRTF data to a trained classifier to generate the user classification; and input the user classification to a trained decoder to generate the predicted HRTF data.

Example 8 includes the device of Example 7, wherein: the trained encoder is included in a variational autoencoder and is trained to generate the encoded HRTF data based on a second latent space HRTF encoding; the trained classifier comprises a deep neural network (DNN) that is trained to classify the encoded HRTF data as one or more of the plurality of user classifications; and the trained decoder is included in a conditional variational autoencoder and is trained to generate the predicted HRTF data based on at least the user classification and the latent space HRTF encoding.

Example 9 includes the device of Example 8, wherein the second latent space HRTF encoding is associated with a first feature space having a first number of dimensions, and wherein the latent space HRTF encoding is associated with a second feature space having a second number of dimensions that is greater than the first number.

Example 10 includes the device of any of Examples 1 to 9 and further includes a modem coupled to the one or more processors, the modem configured to receive the user classification, to transmit the spatial audio data to a second device, or both.

Example 11 includes the device of any of Examples 1 to 10 and further includes one or more speakers coupled to the one or more processors, the one or more speakers configured to render an audio output based on the spatial audio data.

Example 12 includes the device of any of Examples 1 to 11, wherein the one or more processors are integrated in a headset device, the headset device configured to enable playback of the spatial audio data.

Example 13 includes the device of any of Examples 1 to 11, wherein the one or more processors are integrated in a vehicle.

Example 14 includes the device of any of Examples 1 to 11, wherein the one or more processors are integrated in at least one of a mobile phone, a tablet computer device, a wearable electronic device, or a camera device.

Example 15 includes the device of any of Examples 1 to 14 and further includes one or more cameras coupled to the one or more processors, wherein the user classification is based on image data from the one or more cameras.

According to Example 16, a method includes: obtaining, by one or more processors, a user classification associated with a user of a device, the user classification associating the user with at least one of a plurality of user classifications; extracting, by the one or more processors, from a latent space head-related transfer function (HRTF) encoding based on the user classification, predicted HRTF data that represents parameters of a predicted HRTF associated with the user; and outputting, by the one or more processors, spatial audio data based on audio data and the predicted HRTF data.

Example 17 includes the method of Example 16, wherein extracting the predicted HRTF data includes inputting the user classification to a trained decoder to generate the predicted HRTF data, and wherein the trained decoder is included in a conditional variational autoencoder and is trained to generate the predicted HRTF data based on at least the user classification and the latent space HRTF encoding.

Example 18 includes the method of Example 16 and further includes inputting the user classification to a trained decoder to generate the predicted HRTF data.

Example 19 includes the method of Example 18, wherein the trained decoder is included in a conditional variational autoencoder and is trained to generate the predicted HRTF data based on at least the user classification and the latent space HRTF encoding.

Example 20 includes the method of any of Examples 16 to 19 and further includes extracting the predicted HRTF data based further on direction data that indicates a direction of a sound source that corresponds to the spatial audio data.

Example 21 includes the method of any of Examples 16 to 20 and further includes extracting the predicted HRTF data based further on distance data that indicates a distance between the device and a sound source that corresponds to the spatial audio data.

Example 22 includes the method of any of Examples 16 to 21 and further includes extracting the predicted HRTF data based further on room data that corresponds to a room impulse response function (RIR) of a room in which the device is located.

Example 23 includes the method of any of Examples 16 to 22 and further includes: inputting HRTF data to a trained encoder to generate encoded HRTF data; inputting the encoded HRTF data to a trained classifier to generate the user classification; and inputting the user classification to a trained decoder to generate the predicted HRTF data.

Example 24 includes the method of Example 23, wherein: the trained encoder is included in a variational autoencoder and is trained to generate the encoded HRTF data based on a second latent space HRTF encoding; the trained classifier comprises a deep neural network (DNN) that is trained to classify the encoded HRTF data as one or more of the plurality of user classifications; and the trained decoder is included in a conditional variational autoencoder and is trained to generate the predicted HRTF data based on at least the user classification and the latent space HRTF encoding.

Example 25 includes the method of Example 24, wherein the second latent space HRTF encoding is associated with a first feature space having a first number of dimensions, and wherein the latent space HRTF encoding is associated with a second feature space having a second number of dimensions that is greater than the first number.

According to Example 26, a device includes a memory configured to store head-related transfer function (HRTF) data associated with a user of the device. The device also includes one or more processors coupled to the memory, wherein the one or more processors are configured to: obtain the HRTF data; input the HRTF data to a trained encoder to generate encoded HRTF data; classify the encoded HRTF data to generate a user classification associated with the HRTF data; and output the user classification that associates the user with at least one candidate user of a plurality of predefined candidate users.

Example 27 includes the device of Example 26, wherein the one or more processors are further configured to input the encoded HRTF data to a trained classifier to generate the user classification.

Example 28 includes the device of Example 27, wherein: the trained encoder is included in a variational autoencoder and is trained to generate the encoded HRTF data based on a first latent space HRTF encoding; and the trained classifier includes a deep neural network (DNN) that is trained to classify the encoded HRTF data as one or more of a plurality of user classifications.

Example 29 includes the device of Example 28, wherein the one or more processors are further configured to extract, based on the user classification, predicted HRTF data that represents parameters of a predicted HRTF associated with the user.

Example 30 includes the device of Example 29, wherein the one or more processors are further configured to input the user classification to a trained decoder to generate the predicted HRTF data, wherein the trained decoder is included in a conditional variational autoencoder and is trained to generate the predicted HRTF data based on at least the user classification and a second latent space HRTF encoding.

Example 31 includes the device of any of Examples 26 to 30, wherein the one or more processors are further configured to: receive feedback data based on the user classification; and perform, based on the feedback data, an optimization operation on one or more parameters associated with the trained encoder.

Example 32 includes the device of any of Examples 26 to 31, wherein the user classification includes a first score associated with a first user classification of a plurality of user classifications and a second score associated with a second user classification of the plurality of user classifications.

Example 33 includes the device of any of Examples 26 to 32, wherein the HRTF data includes measurement data representing one or more measurements of an ear of the user, one or more sample HRTF measurements, or a combination thereof.

Example 34 includes the device of any of Examples 26 to 33, wherein the HRTF data includes image data that represents one or more images of an ear of the user.

Example 35 includes the device of Example 34 and further includes one or more cameras coupled to the one or more processors, the one or more cameras configured to generate the image data.

Example 36 includes the device of any of Examples 26 to 35 and further includes a modem coupled to the one or more processors, the modem configured to receive the HRTF data, to transmit the user classification to a second device, or both.

Example 37 includes the device of any of Examples 26 to 36, wherein the one or more processors are integrated in at least one of a mobile phone, a tablet computer device, a wearable electronic device, or a camera device.

Example 38 includes the device of any of Examples 26 to 36, wherein the one or more processors are integrated in a vehicle.

Example 39 includes the device of any of Examples 26 to 36, wherein the one or more processors are integrated in a headset device.

According to Example 40, a method includes: obtaining, by one or more processors, head-related transfer function (HRTF) data associated with a user of a device; inputting, by the one or more processors, the HRTF data to a trained encoder to generate encoded HRTF data; classifying, by the one or more processors, the encoded HRTF data to generate a user classification associated with the HRTF data; and outputting, by the one or more processors, the user classification that associates the user with at least one candidate user of a plurality of predefined candidate users.

Example 41 includes the method of Example 40, wherein classifying the encoded HRTF data includes inputting, by the one or more processors, the encoded HRTF data to a trained classifier to generate the encoded HRTF data, wherein the trained encoder is included in a variational autoencoder and is trained to generate the encoded HRTF data based on a first latent space HRTF encoding, and wherein the trained classifier includes a deep neural network (DNN) that is trained to classify the encoded HRTF data as one or more of a plurality of user classifications.

Example 42 includes the method of Example 40 and further includes inputting the encoded HRTF data to a trained classifier to generate the user classification.

Example 43 includes the method of Example 42, wherein: the trained encoder is included in a variational autoencoder and is trained to generate the encoded HRTF data based on a first latent space HRTF encoding; and the trained classifier includes a deep neural network (DNN) that is trained to classify the encoded HRTF data as one or more of a plurality of user classifications.

Example 44 includes the method of Example 43 and further includes extracting based on the user classification, predicted HRTF data that represents parameters of a predicted HRTF associated with the user.

Example 45 includes the method of Example 44 and further includes inputting the user classification to a trained decoder to generate the predicted HRTF data, wherein the trained decoder is included in a conditional variational autoencoder and is trained to generate the predicted HRTF data based on at least the user classification and a second latent space HRTF encoding.

Example 46 includes the method of any of Examples 40 to 45 and further includes: receiving feedback data based on the user classification; and performing, based on the feedback data, an optimization operation on one or more parameters associated with the trained encoder.

Example 47 includes the method of any of Examples 40 to 46, wherein the user classification includes a first score associated with a first user classification of a plurality of user classifications and a second score associated with a second user classification of the plurality of user classifications.

Example 48 includes the method of any of Examples 40 to 47, wherein the HRTF data includes measurement data representing one or more measurements of an ear of the user, one or more sample HRTF measurements, or a combination thereof.

Example 49 includes the method of any of Examples 40 to 48, wherein the HRTF data includes image data that represents one or more images of an ear of the user.

According to Example 50, an apparatus includes: means for obtaining a user classification associated with a user of a device, the user classification associating the user with at least one of a plurality of user classifications; means for extracting, from a latent space head-related transfer function (HRTF) encoding based on the user classification, predicted HRTF data that represents parameters of a predicted HRTF associated with the user; and means for outputting spatial audio data based on audio data and the predicted HRTF data.

Example 51 includes the apparatus of Example 50, wherein the means for extracting includes trained means for decoding the user classification to generate the predicted HRTF data.

Example 52 includes the apparatus of Example 51, wherein the trained means for decoding is included in a conditional variational autoencoder and is trained to generate the predicted HRTF data based on at least the user classification and the latent space HRTF encoding.

Example 53 includes the apparatus of any of Examples 50 to 52, wherein the means for extracting is configured to extract the predicted HRTF data based further on direction data that indicates a direction of a sound source that corresponds to the spatial audio data.

Example 54 includes the apparatus of any of Examples 50 to 53, wherein the means for extracting is configured to extract the predicted HRTF data based further on distance data that indicates a distance between the device and a sound source that corresponds to the spatial audio data.

Example 55 includes the apparatus of any of Examples 50 to 54, wherein the means for extracting is configured to extract the predicted HRTF data based further on room data that corresponds to a room impulse response function (RIR) of a room in which the device is located.

Example 56 includes the apparatus of any of Examples 50 to 55 and further includes trained means for encoding the HRTF data to generate encoded HRTF data; and trained means for classifying the encoded HRTF data to generate the user classification; and wherein the means for extracting includes trained means for decoding the user classification to generate the predicted HRTF data.

Example 57 includes the apparatus of Example 56, wherein: the trained means for encoding is included in a variational autoencoder and is trained to generate the encoded HRTF data based on a second latent space HRTF encoding; the trained means for classifying comprises a deep neural network (DNN) that is trained to classify the encoded HRTF data as one or more of the plurality of user classifications; and the trained means for decoding is included in a conditional variational autoencoder and is trained to generate the predicted HRTF data based on at least the user classification and the latent space HRTF encoding.

Example 58 includes the apparatus of Example 57, wherein the second latent space HRTF encoding is associated with a first feature space having a first number of dimensions, and wherein the latent space HRTF encoding is associated with a second feature space having a second number of dimensions that is greater than the first number.

According to Example 59, a non-transitory computer-readable medium stores instructions that are executable by one or more processors to cause the one or more processors to: obtain a user classification associated with a user of a device, the user classification associating the user with at least one of a plurality of user classifications; extract from a latent space head-related transfer function (HRTF) encoding based on the user classification, predicted HRTF data that represents parameters of a predicted HRTF associated with the user; and output spatial audio data based on audio data and the predicted HRTF data.

Example 60 includes the non-transitory computer-readable medium of Example 59, wherein extracting the predicted HRTF data includes inputting the user classification to a trained decoder to generate the predicted HRTF data, and wherein the trained decoder is included in a conditional variational autoencoder and is trained to generate the predicted HRTF data based on at least the user classification and the latent space HRTF encoding.

Example 61 includes the non-transitory computer-readable medium of Example 59, wherein the instructions are executable by the one or more processors to further cause the one or more processors to input the user classification to a trained decoder to generate the predicted HRTF data.

Example 62 includes the non-transitory computer-readable medium of Example 61, wherein the trained decoder is included in a conditional variational autoencoder and is trained to generate the predicted HRTF data based on at least the user classification and the latent space HRTF encoding.

Example 63 includes the non-transitory computer-readable medium of any of Examples 59 to 62, wherein the instructions are executable by the one or more processors to further cause the one or more processors to extract the predicted HRTF data based further on direction data that indicates a direction of a sound source that corresponds to the spatial audio data.

Example 64 includes the non-transitory computer-readable medium of any of Examples 59 to 63, wherein the instructions are executable by the one or more processors to further cause the one or more processors to extract the predicted HRTF data based further on distance data that indicates a distance between the device and a sound source that corresponds to the spatial audio data.

Example 65 includes the non-transitory computer-readable medium of any of Examples 59 to 64, wherein the instructions are executable by the one or more processors to further cause the one or more processors to extract the predicted HRTF data based further on room data that corresponds to a room impulse response function (RIR) of a room in which the device is located.

Example 66 includes the non-transitory computer-readable medium of any of Examples 59 to 65, wherein the instructions are executable by the one or more processors to further cause the one or more processors to: input HRTF data to a trained encoder to generate encoded HRTF data; input the encoded HRTF data to a trained classifier to generate the user classification; and input the user classification to a trained decoder to generate the predicted HRTF data.

Example 67 includes the non-transitory computer-readable medium of Example 66, wherein: the trained encoder is included in a variational autoencoder and is trained to generate the encoded HRTF data based on a second latent space HRTF encoding; the trained classifier comprises a deep neural network (DNN) that is trained to classify the encoded HRTF data as one or more of the plurality of user classifications; and the trained decoder is included in a conditional variational autoencoder and is trained to generate the predicted HRTF data based on at least the user classification and the latent space HRTF encoding.

Example 68 includes the non-transitory computer-readable medium of Example 67, wherein the second latent space HRTF encoding is associated with a first feature space having a first number of dimensions, and wherein the latent space HRTF encoding is associated with a second feature space having a second number of dimensions that is greater than the first number.

According to Example 70, an apparatus includes: means for obtaining head-related transfer function (HRTF) data associated with a user of a device; trained encoding means for generating encoded HRTF data based on the HRTF data; means for classifying the encoded HRTF data to generate a user classification associated with the HRTF data; and means for outputting the user classification that associates the user with at least one candidate user of a plurality of predefined candidate users.

Example 71 includes the apparatus of Example 70, wherein the means for classifying include trained means for classifying the encoded HRTF data to generate the user classification.

Example 72 includes the apparatus of Example 71, wherein: the trained encoding means is included in a variational autoencoder and is trained to generate the encoded HRTF data based on a first latent space HRTF encoding; and the trained means for classifying includes a deep neural network (DNN) that is trained to classify the encoded HRTF data as one or more of a plurality of user classifications.

Example 73 includes the apparatus of Example 72 and further includes means for extracting, based on the user classification, predicted HRTF data that represents parameters of a predicted HRTF associated with the user.

Example 74 includes the apparatus of Example 73 and further includes trained means for decoding the user classification to generate the predicted HRTF data, wherein the trained means for decoding is included in a conditional variational autoencoder and is trained to generate the predicted HRTF data based on at least the user classification and a second latent space HRTF encoding.

Example 75 includes the apparatus of any of Examples 70 to 74 and further includes: means for receiving feedback data based on the user classification; and means for performing, based on the feedback data, an optimization operation on one or more parameters associated with the trained encoder.

Example 76 includes the apparatus of any of Examples 70 to 75, wherein the user classification includes a first score associated with a first user classification of a plurality of user classifications and a second score associated with a second user classification of the plurality of user classifications.

Example 77 includes the apparatus of any of Examples 70 to 76, wherein the HRTF data includes measurement data representing one or more measurements of an ear of the user, one or more sample HRTF measurements, or a combination thereof.

Example 78 includes the apparatus of any of Examples 70 to 77, wherein the HRTF data includes image data that represents one or more images of an ear of the user.

According to Example 79, a non-transitory computer-readable medium stores instructions that are executable by one or more processors to cause the one or more processors to: obtain head-related transfer function (HRTF) data associated with a user of a device; input the HRTF data to a trained encoder to generate encoded HRTF data; classify the encoded HRTF data to generate a user classification associated with the HRTF data; and output the user classification that associates the user with at least one candidate user of a plurality of predefined candidate users.

Example 80 includes the non-transitory computer-readable medium of Example 79, wherein classifying the encoded HRTF data includes inputting, by the one or more processors, the encoded HRTF data to a trained classifier to generate the encoded HRTF data, wherein the trained encoder is included in a variational autoencoder and is trained to generate the encoded HRTF data based on a first latent space HRTF encoding, and wherein the trained classifier includes a deep neural network (DNN) that is trained to classify the encoded HRTF data as one or more of a plurality of user classifications.

Example 81 includes the non-transitory computer-readable medium of Example 79, wherein the instructions are executable by the one or more processors to further cause the one or more processors to input the encoded HRTF data to a trained classifier to generate the user classification.

Example 82 includes the non-transitory computer-readable medium of Example 81, wherein: the trained encoder is included in a variational autoencoder and is trained to generate the encoded HRTF data based on a first latent space HRTF encoding; and the trained classifier includes a deep neural network (DNN) that is trained to classify the encoded HRTF data as one or more of a plurality of user classifications.

Example 83 includes the non-transitory computer-readable medium of Example 82, wherein the instructions are executable by the one or more processors to further cause the one or more processors to extract, based on the user classification, predicted HRTF data that represents parameters of a predicted HRTF associated with the user.

Example 84 includes the non-transitory computer-readable medium of Example 83, wherein the instructions are executable by the one or more processors to further cause the one or more processors to input the user classification to a trained decoder to generate the predicted HRTF data, wherein the trained decoder is included in a conditional variational autoencoder and is trained to generate the predicted HRTF data based on at least the user classification and a second latent space HRTF encoding.

Example 85 includes the non-transitory computer-readable medium of any of Examples 79 to 84, wherein the instructions are executable by the one or more processors to further cause the one or more processors to: receive feedback data based on the user classification; and perform, based on the feedback data, an optimization operation on one or more parameters associated with the trained encoder.

Example 86 includes the non-transitory computer-readable medium of any of Examples 79 to 85, wherein the user classification includes a first score associated with a first user classification of a plurality of user classifications and a second score associated with a second user classification of the plurality of user classifications.

Example 87 includes the non-transitory computer-readable medium of any of Examples 79 to 86, wherein the HRTF data includes measurement data representing one or more measurements of an ear of the user, one or more sample HRTF measurements, or a combination thereof.

Example 88 includes the non-transitory computer-readable medium of any of Examples 79 to 87, wherein the HRTF data includes image data that represents one or more images of an ear of the user.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store a user classification associated with a user of the device, the user classification associating the user with at least one of a plurality of user classifications; and
one or more processors coupled to the memory, wherein the one or more processors are configured to:
obtain the user classification;
extract, from a latent space head-related transfer function (HRTF) encoding based on the user classification, predicted HRTF data that represents parameters of a predicted HRTF associated with the user; and
output spatial audio data based on audio data and the predicted HRTF data.

2. The device of claim 1, wherein the one or more processors are further configured to input the user classification to a trained decoder to generate the predicted HRTF data.

3. The device of claim 2, wherein the trained decoder is included in a conditional variational autoencoder and is trained to generate the predicted HRTF data based on at least the user classification and the latent space HRTF encoding.

4. The device of claim 1, wherein the one or more processors are configured to extract the predicted HRTF data based further on direction data that indicates a direction of a sound source that corresponds to the spatial audio data.

5. The device of claim 1, wherein the one or more processors are configured to extract the predicted HRTF data based further on distance data that indicates a distance between the device and a sound source that corresponds to the spatial audio data.

6. The device of claim 1, wherein the one or more processors are configured to extract the predicted HRTF data based further on room data that corresponds to a room impulse response function (RIR) of a room in which the device is located.

7. The device of claim 1, wherein the one or more processors are further configured to:
input HRTF data to a trained encoder to generate encoded HRTF data;
input the encoded HRTF data to a trained classifier to generate the user classification; and
input the user classification to a trained decoder to generate the predicted HRTF data.

8. The device of claim 7, wherein:
the trained encoder is included in a variational autoencoder and is trained to generate the encoded HRTF data based on a second latent space HRTF encoding;
the trained classifier comprises a deep neural network (DNN) that is trained to classify the encoded HRTF data as one or more of the plurality of user classifications; and
the trained decoder is included in a conditional variational autoencoder and is trained to generate the predicted HRTF data based on at least the user classification and the latent space HRTF encoding.

9. The device of claim 8, wherein the second latent space HRTF encoding is associated with a first feature space having a first number of dimensions, and wherein the latent space HRTF encoding is associated with a second feature space having a second number of dimensions that is greater than the first number.

10. The device of claim 1, further comprising a modem coupled to the one or more processors, the modem configured to receive the user classification, to transmit the spatial audio data to a second device, or both.

11. The device of claim 1, further comprising one or more speakers coupled to the one or more processors, the one or more speakers configured to render an audio output based on the spatial audio data.

12. The device of claim 1, wherein the one or more processors are integrated in a headset device, the headset device configured to enable playback of the spatial audio data.

13. The device of claim 1, wherein the one or more processors are integrated in a vehicle.

14. A method comprising:
obtaining, by one or more processors, a user classification associated with a user of a device, the user classification associating the user with at least one of a plurality of user classifications;
extracting, by the one or more processors, from a latent space head-related transfer function (HRTF) encoding based on the user classification, predicted HRTF data that represents parameters of a predicted HRTF associated with the user; and
outputting, by the one or more processors, spatial audio data based on audio data and the predicted HRTF data.

15. The method of claim 14, wherein extracting the predicted HRTF data includes inputting the user classification to a trained decoder to generate the predicted HRTF data, and wherein the trained decoder is included in a conditional variational autoencoder and is trained to generate the predicted HRTF data based on at least the user classification and the latent space HRTF encoding.

16. A device comprising:
a memory configured to store head-related transfer function (HRTF) data associated with a user of the device; and
one or more processors coupled to the memory, wherein the one or more processors are configured to:
obtain the HRTF data;
input the HRTF data to a trained encoder to generate encoded HRTF data;
classify the encoded HRTF data to generate a user classification associated with the HRTF data; and
output the user classification that associates the user with at least one candidate user of a plurality of predefined candidate users.

17. The device of claim 16, wherein the one or more processors are further configured to:
input the encoded HRTF data to a trained classifier to generate the user classification.

18. The device of claim 17, wherein:
the trained encoder is included in a variational autoencoder and is trained to generate the encoded HRTF data based on a first latent space HRTF encoding; and
the trained classifier includes a deep neural network (DNN) that is trained to classify the encoded HRTF data as one or more of a plurality of user classifications.

19. The device of claim 18, wherein the one or more processors are further configured to:
extract, based on the user classification, predicted HRTF data that represents parameters of a predicted HRTF associated with the user.

20. The device of claim 19, wherein the one or more processors are further configured to:
input the user classification to a trained decoder to generate the predicted HRTF data, wherein the trained decoder is included in a conditional variational autoencoder and is trained to generate the predicted HRTF data based on at least the user classification and a second latent space HRTF encoding.

21. The device of claim 16, wherein the one or more processors are further configured to:
receive feedback data based on the user classification; and
perform, based on the feedback data, an optimization operation on one or more parameters associated with the trained encoder.

22. The device of claim 16, wherein the user classification includes a first score associated with a first user classification of a plurality of user classifications and a second score associated with a second user classification of the plurality of user classifications.

23. The device of claim 16, wherein the HRTF data includes measurement data representing one or more measurements of an ear of the user, one or more sample HRTF measurements, or a combination thereof.

24. The device of claim 16, wherein the HRTF data includes image data that represents one or more images of an ear of the user.

25. The device of claim 24, further comprising one or more cameras coupled to the one or more processors, the one or more cameras configured to generate the image data.

26. The device of claim 16, further comprising a modem coupled to the one or more processors, the modem configured to receive the HRTF data, to transmit the user classification to a second device, or both.

27. The device of claim 16, wherein the one or more processors are integrated in at least one of a mobile phone, a tablet computer device, a wearable electronic device, or a camera device.

28. The device of claim 16, wherein the one or more processors are integrated in a vehicle.

29. A method comprising:
obtaining, by one or more processors, head-related transfer function (HRTF) data associated with a user of a device;
inputting, by the one or more processors, the HRTF data to a trained encoder to generate encoded HRTF data;
classifying, by the one or more processors, the encoded HRTF data to generate a user classification associated with the HRTF data; and
outputting, by the one or more processors, the user classification that associates the user with at least one candidate user of a plurality of predefined candidate users.

30. The method of claim 29, wherein classifying the encoded HRTF data includes inputting, by the one or more processors, the encoded HRTF data to a trained classifier to generate the user classification, wherein the trained encoder is included in a variational autoencoder and is trained to generate the encoded HRTF data based on a first latent space HRTF encoding, and wherein the trained classifier includes a deep neural network (DNN) that is trained to classify the encoded HRTF data as one or more of a plurality of user classifications.
